(19) United States
(12) Patent Application Publication
(10) Pub. No.: US 2025/0053202 A1
(43) Pub. Date: Feb. 13, 2025

(54) ELECTRONIC DEVICE FOR IDENTIFYING MOVEMENT ON BASIS OF ACCELERATION SENSORS, AND METHOD THEREFOR

(71) Applicant: SAMSUNG ELECTRONICS CO., LTD., Suwon-si (KR)

(72) Inventors: Seajung OH, Suwon-si (KR); Sunghun SHIN, Suwon-si (KR)

(73) Assignee: SAMSUNG ELECTRONICS CO., LTD., Suwon-si (KR)

(21) Appl. No.: 18/924,594

(22) Filed: Oct. 23, 2024

Related U.S. Application Data
(63) Continuation of application No. PCT/KR2023/003964, filed on Mar. 24, 2023.

(30) Foreign Application Priority Data
May 27, 2022 (KR) 10-2022-0065692

(51) Int. Cl. G06F 1/16; G01P 15/08; G01P 15/18

(52) U.S. Cl. CPC G06F 1/1681; G01P 15/08; G01P 15/18; G06F 1/1652

(57) ABSTRACT

An electronic device includes: a deformable housing along at least one folding axis; a plurality of acceleration sensors respectively positioned at portions of the deformable housing; a controller operably coupled to the plurality of acceleration sensors, wherein the controller is configured to: receive, from the plurality of acceleration sensors, interrupt signals indicating that the electronic device is moved by acceleration of gravity applied to the electronic device; based on the received interrupt signals and based on acceleration measured by the plurality of acceleration sensors, receive data signals; and based on the received data signals, obtain, at least one of duration, a distance that the electronic device is moved in accordance with the acceleration of gravity, or an impulse applied to the electronic device based on movement of the electronic device, which corresponds to the acceleration of gravity.

### CROSS-REFERENCE TO RELATED APPLICATIONS

This application is a by-pass continuation application of International Application No. PCT/KR2023/003964, filed on Mar. 24, 2023, which is based on and claims priority to Korean Patent Application No. 10-2022-0065692, filed on May 27, 2022, in the Korean Intellectual Property Office, the disclosures of which are incorporated by reference herein their entireties.

### BACKGROUND

### 1. Field

The disclosure relates to an electronic device for identifying a movement on a basis of acceleration sensors, and a method performed by the electronic device.

### 2. Description of Related Art

Using a flexible display, an electronic device having a deformable form factor in an activated state (e.g., “on” state) has been developed. A housing of the electronic device may have a foldable structure based on a hinge. The electronic device may provide a user experience based on a shape of the electronic device to the user by using the flexible display positioned across different portions of the housing divided by the hinge. For example, based on the shape of the flexible display, which is folded or unfolded by a user's external force, the electronic device may change content displayed on the flexible display.

### SUMMARY

According to an aspect of the disclosure, an electronic device includes: a deformable housing along at least one folding axis; a plurality of acceleration sensors respectively positioned at portions of the deformable housing; a controller operably coupled to the plurality of acceleration sensors, wherein the controller is configured to: receive, from the plurality of acceleration sensors, interrupt signals indicating that the electronic device is moved by acceleration of gravity applied to the electronic device; based on the received interrupt signals and based on acceleration measured by the plurality of acceleration sensors, receive data signals; and based on the received data signals, obtain, at least one of duration, a distance that the electronic device is moved in accordance with the acceleration of gravity, or an impulse applied to the electronic device based on movement of the electronic device, which corresponds to the acceleration of gravity.

According to an aspect of the disclosure, a method of an electronic device, includes: receiving, from a plurality of acceleration sensors positioned in distinct portions of the electronic device, interrupt signals indicating that the electronic device is moved in accordance with acceleration of gravity applied to the electronic device; based on the received interrupt signals and based on acceleration measured by the plurality of acceleration sensors, receiving data signals; and based on the data signals, obtaining, at least one of duration, a distance that the electronic device is moved in accordance with the acceleration of gravity, or an impulse applied to the electronic device based on the movement of the electronic device, which corresponds to the acceleration of gravity.

According to an aspect of the disclosure, an electronic device includes: a housing comprising a plurality of portions pivotably interconnected based on a folding axis; a plurality of acceleration sensors configured to identify an angle between the plurality of portions, and the folding axis, wherein the plurality of acceleration sensors are respectively positioned at the plurality of portions; and a controller operably coupled to the plurality of acceleration sensors; wherein the controller is configured to be coupled to: the plurality of acceleration sensors, via a plurality of signal paths, configured to receive a data signal indicating acceleration measured by the plurality of acceleration sensors, wherein the plurality of signal paths comprise a first signal path; a first acceleration sensor among the plurality of acceleration sensors via a second signal path, which is different from the first signal path, for receiving an interrupt signal indicating that a movement of the electronic device based on acceleration of gravity is identified by the first acceleration sensor; and a second acceleration sensor among the plurality of acceleration sensors via a third signal path, which is different from the first signal path and the second signal path, for receiving another interrupt signal indicating that the movement of the electronic device based on the acceleration of gravity is identified by the second acceleration sensor.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an electronic device in a network environment according to one or more embodiments;

FIG. 2 is a diagram illustrating an unfolded status of an electronic device according to one or more embodiments of the disclosure;

FIG. 3 is a diagram illustrating a folded status of an electronic device according to one or more embodiments of the disclosure;

FIG. 4 is a perspective view illustrating an example of a fully unfolded status or a partially unfolded intermediate status of an electronic device according to one or more embodiments of the disclosure;

FIGS. 5A to 5C illustrate positions of a plurality of acceleration sensors in an electronic device according to an embodiment;

FIGS. 6A to 6B illustrate an example block diagram of a plurality of acceleration sensors and a controller of an electronic device according to an embodiment;

FIG. 7 illustrates an example block diagram of a controller configured to control a plurality of acceleration sensors of an electronic device according to an embodiment;

FIG. 8 illustrates an example block diagram of a processor configured to control a plurality of acceleration sensors of an electronic device according to an embodiment;

FIG. 9 illustrates a block diagram of any one of a plurality of acceleration sensors of an electronic device according to an embodiment;

FIG. 10 illustrates an example graph of magnitudes of acceleration measured from a plurality of acceleration sensors of an electronic device according to an embodiment;

FIG. 11 illustrates an example signal flowchart between a controller and a plurality of acceleration sensors of an electronic device according to an embodiment;

FIG. 12 is an example flowchart of a plurality of acceleration sensors of an electronic device according to an embodiment;

FIG. 13 is an example flowchart of a controller connected to a plurality of acceleration sensors of an electronic device according to an embodiment;

FIG. 14 is an example signal flowchart between a controller and a plurality of acceleration sensors of an electronic device according to an embodiment;

FIG. 15 is an example flowchart of a plurality of acceleration sensors of an electronic device according to an embodiment;

FIG. 16 is an example flowchart of a controller connected to a plurality of acceleration sensors of an electronic device according to an embodiment; and

FIG. 17 is an example flowchart of a controller connected to a plurality of acceleration sensors of an electronic device according to an embodiment.

### DETAILED DESCRIPTION

Hereinafter, one or more embodiments of the present document may be described with reference to the accompanying drawings.

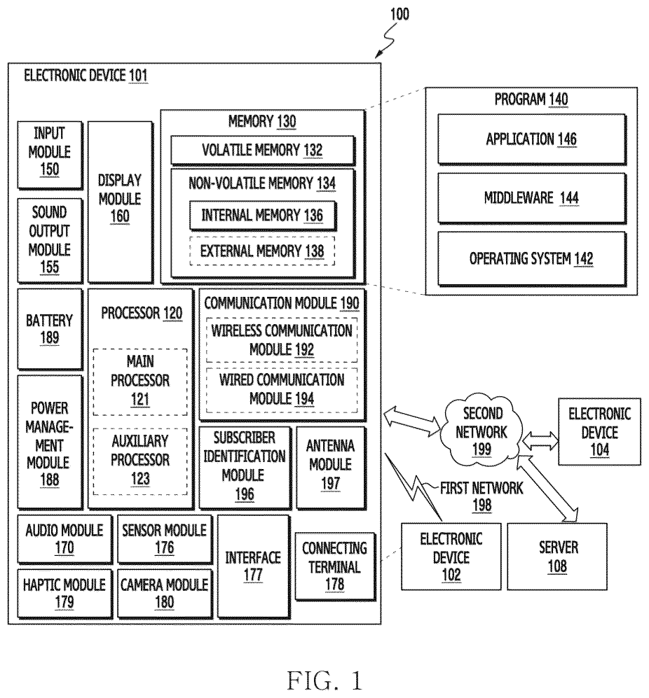

FIG. 1 is a block diagram illustrating an electronic device 101 in a network environment 100 according to one or more embodiments.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to one or more embodiments, the antenna module 197 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 may perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

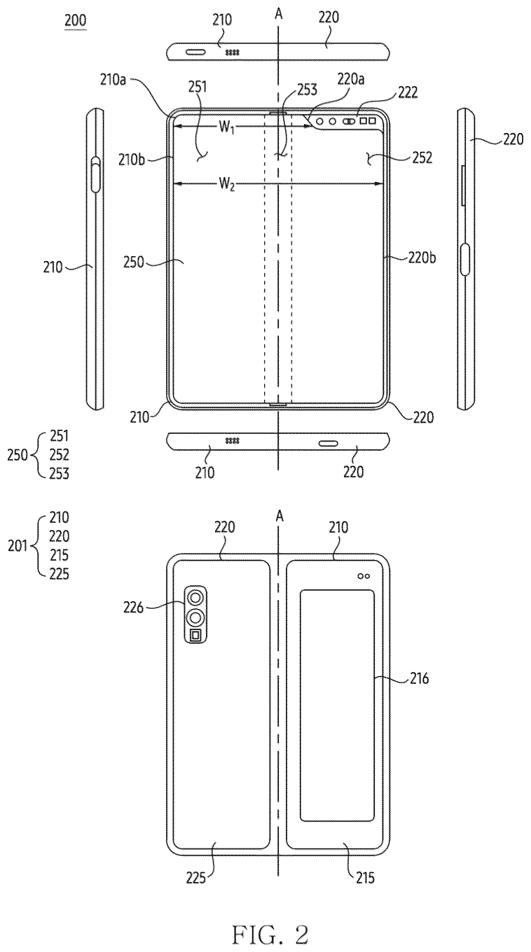

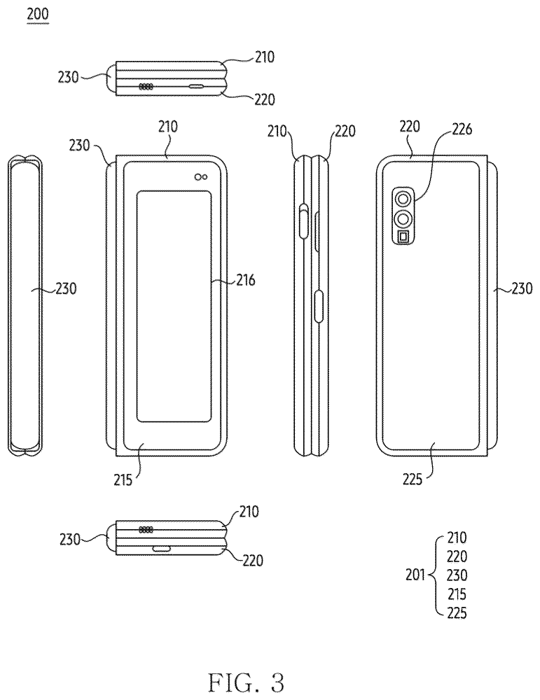

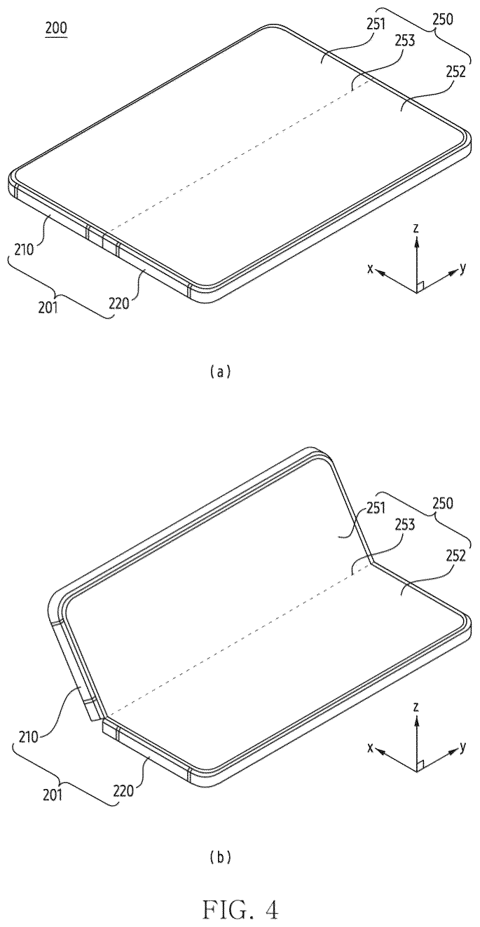

FIG. 2 is a diagram illustrating an unfolded status of an electronic device 200 according to one or more embodiments of the disclosure. FIG. 3 is a diagram illustrating a folded status of an electronic device 200 according to one or more embodiments of the disclosure. FIG. 4 is a perspective view illustrating an example of a fully unfolded status or a partially unfolded intermediate status of an electronic device 200 according to one or more embodiments of the disclosure.

The electronic device 200 of FIGS. 2 to 4 is an example of the electronic device 101 illustrated in FIG. 1, and may be a foldable or bendable electronic device.

For example, in FIG. 4, a spatial coordinate system defined by an x-axis, y-axis, and z-axis that are orthogonal to each other is illustrated. Herein, the x-axis may indicate a width direction of the electronic device, the y-axis may indicate a length direction of the electronic device, and the z-axis may indicate a height (or thickness) direction of the electronic device. In the following description, ‘a first direction’ may mean a direction parallel to the z-axis.

Referring to FIGS. 2 and 3, in an embodiment, the electronic device 200 may include a foldable housing 201 and a flexible or foldable display 250 (hereinafter, “display” 250 for short) (e.g., the display module 160 of FIG. 1). According to an embodiment, a surface (or a surface in which the display 250 is viewed from the outside of the electronic device 200) on which the display 250 is positioned may be defined as a front surface of the electronic device 200. Also, a surface opposite to the front surface may be defined as a rear surface of the electronic device 200. Furthermore, a surface surrounding a space between the front surface and the rear surface may be defined as a side surface of the electronic device 200.

According to one or more embodiments, the foldable housing 201 may include a first housing structure 210, a second housing structure 220 including a sensor area 222, a first rear cover 215, a second rear cover 225, and a hinge structure 230. Herein, the hinge structure 230 may include a hinge cover covering a foldable portion of the foldable housing 201. The foldable housing 201 of the electronic device 200 is not limited to a shape and coupling illustrated in FIGS. 2 and 3, and may be implemented by a combination and/or coupling of other shapes or components. For example, in another embodiment, the first housing structure 210 and the first rear cover 215 may be integrally formed, and the second housing structure 220 and the second rear cover 225 may be integrally formed.

According to one or more embodiments, the first housing structure 210 may be connected to the hinge structure 230, and may include a first surface facing in a first direction and a second surface facing in a second direction opposite to the first direction. The second housing structure 220 may be connected to the hinge structure 230, and may include a third surface facing in a third direction and a fourth surface facing in a fourth direction opposite to the third direction. The second housing structure 220 may rotate with respect to the first housing structure 210 based on the hinge structure 230. The electronic device 200 may be changed into a folded status or an unfolded status.

According to an embodiment, while the electronic device 200 is in a fully folded status, the first surface may face the third surface, and the third direction may be the same as the first direction in the fully unfolded status.

According to one or more embodiments, the first housing structure 210 and the second housing structure 220 may be positioned on both sides of a folding axis A, and may have a shape that is generally symmetrical with respect to the folding axis A. As will be described later, an angle or a distance between the first housing structure 210 and the second housing structure 220 may vary according to whether a status of the electronic device 200 is an unfolded status, a folded status, or a partially unfolded (or partially folded) intermediate status. According to an embodiment, unlike the first housing structure 210, the second housing structure 220 may further include the sensor area 222 in which various sensors are positioned, but may have a mutual symmetrical shape in other areas.

According to one or more embodiments, as illustrated in FIG. 2, the first housing structure 210 and the second housing structure 220 may form a recess accommodating the display 250 together. According to an embodiment, the recess may have two or more different widths in a direction perpendicular to the folding axis A, by the sensor area 222.

According to an embodiment, the recess may have a first width w1 between a first portion 210a parallel to the folding axis A of the first housing structure 210 and a first portion 220a formed at a periphery of the sensor area 222 of the second housing structure 220. The recess may have a second width w2 formed by a second portion 210b, and a second portion 220b which does not correspond to the sensor area 222 and is parallel to the folding axis A. In this case, the second width w2 may be formed to be longer than the first width w1. According to an embodiment, the first portion 220a and the second portion 220b of the second housing structure 220 may have different distances from the folding axis A. A width of the recess is not limited to an illustrated example. In another embodiment, the recess may have a plurality of widths by a portion having a shape of the sensor area 222 or an asymmetric form of the first housing structure 210 and the second housing structure 220. According to one or more embodiments, the sensor area 222 may be formed to have a certain area adjacent to a corner of the second housing structure 220. However, an arrangement, shape, and size of the sensor area 222 are not limited to an illustrated example. For example, in another embodiment, the sensor area 222 may be provided in another corner of the second housing structure 220 or in any area between an upper corner and lower corner. In an embodiment, components for performing various functions embedded in the electronic device 200 may be exposed to the front surface of the electronic device 200 through the sensor area 222 or through one or more openings provided in the sensor area 222. In one or more embodiments, the components may include various types of sensors. The sensor may include, for example, at least one of a front camera, a receiver, or a proximity sensor. According to one or more embodiments, the sensor area 222 may be omitted or formed in a position different from that illustrated in the drawing in the second housing structure 220.

According to one or more embodiments, at least a portion of the first housing structure 210 and the second housing structure 220 may be formed of a metal material or a non-metal material, having rigidity of a size selected to support the display 250. At least a portion formed of the metal material may provide a ground plane of the electronic device 200, and may be electrically connected to a ground line formed on a printed circuit board positioned inside the foldable housing 201.

According to one or more embodiments, the first rear cover 215 may be positioned on a side of the folding axis A of the rear surface of the electronic device 200, for example, may have a substantially rectangular periphery, and the periphery may be surrounded by the first housing structure 210. Similarly, the second rear cover 225 may be positioned on another side of the folding axis A of the rear surface of the electronic device 200, and the periphery of thereof may be surrounded by the second housing structure 220.

According to one or more embodiments, the first rear cover 215 and the second rear cover 225 may have a substantially symmetrical shape with respect to the folding axis A. However, the first rear cover 215 and the second rear cover 225 do not necessarily have a mutually symmetrical shape, and in another embodiment, the electronic device 200 may include a first rear cover 215 and a second rear cover 225 having various shapes. In another embodiment, the first rear cover 215 may be integrally formed with the first housing structure 210, and the second rear cover 225 may be integrally formed with the second housing structure 220.

According to one or more embodiments, the first rear cover 215, the second rear cover 225, the first housing structure 210, and the second housing structure 220 may form a space in which various components (e.g., a printed circuit board or a battery) of the electronic device 200 may be positioned. According to an embodiment, one or more components may be positioned or visually exposed on the rear surface of the electronic device 200. For example, at least a portion of a sub-display may be visually exposed through a first rear area 216 of the first rear cover 215. In another embodiment, one or more components or sensors may be visually exposed through a second rear area 226 of the second rear cover 225. In one or more embodiments, the sensor may include the proximity sensor and/or a rear camera.

According to one or more embodiments, the front camera exposed to the front of the electronic device 200 through one or more openings provided in the sensor area 222 or the rear camera exposed through the second rear area 226 of the second rear cover 225 may include one or more lenses, an image sensor, and/or an image signal processor. A flash may include, for example, a light emitting diode or a xenon lamp. In an embodiment, two or more lenses (infrared camera, wide-angle and telephoto lenses) and image sensors may be positioned on one surface of the electronic device 200.

Referring to FIG. 3, the hinge cover may be configured to cover internal components (e.g., hinge structure 230) by being positioned between the first housing structure 210 and the second housing structure 220. According to an embodiment, the hinge structure 230 may be covered or exposed to the outside by a portion of the first housing structure 310 and the second housing structure 320 according to a status (an unfolded status, an intermediate status, or a folded status) of the electronic device 200.

According to an embodiment, as illustrated in FIG. 2, when the electronic device 200 is in an unfolded status (e.g., a fully unfolded status), the hinge structure 230 may be covered by the first housing structure 210 and the second housing structure 220 and may not be exposed. For another example, as illustrated in FIG. 3, when the electronic device 200 is in a folded status (e.g., a fully folded status), the hinge structure 230 may be exposed to the outside between the first housing structure 210 and the second housing structure 220. For another example, when the first housing structure 210 and the second housing structure 220 are in an intermediate status folded with a certain angle, the hinge structure 230 may be partially exposed to the outside between the first housing structure 210 and the second housing structure 220. However, in this case, an exposed area may be less than that of the fully folded status. In an embodiment, the hinge structure 230 may include a curved surface.

According to one or more embodiments, the display 250 may be positioned on a space formed by the foldable housing 201. For example, the display 250 may be seated on a recess formed by the foldable housing 201 and may be seen from the outside through the front of the electronic device 200. For example, the display 250 may configure most of the front surface of the electronic device 200. Therefore, the front surface of the electronic device 200 may include the display 250 and a partial area of the first housing structure 210 and a partial area of the second housing structure 220 adjacent to the display 250. In addition, the rear surface of the electronic device 200 may include the first rear cover 215, a partial area of the first housing structure 210 adjacent to the first rear cover 215, the second rear cover 225, and a partial area of the second housing structure 220 adjacent to the second rear cover 225.

According to one or more embodiments, the display 250 may mean a display in which at least a partial area may be deformed into a flat surface or a curved surface. According to an embodiment, the display 250 may include a folding area 253 and a first area 251 positioned on a side (e.g., the left side of the folding area 253 illustrated in FIG. 2) and a second area 252 positioned on the other side (e.g., the right side of the folding area 253 illustrated in FIG. 2) based on the folding area 253.

However, an area division of the display 250 illustrated in FIG. 2 is example, and the display 250 may be divided into a plurality of areas (e.g., four or more or two) according to a structure or function. For example, in an embodiment illustrated in FIG. 2, an area of the display 250 may be divided by the folding area 203 extending parallel to the folding axis A, but in another embodiment, the area of the display 250 may be divided based on another folding axis (e.g., a folding axis parallel to the width direction of the electronic device).

According to one or more embodiments of the disclosure, the display 250 may be coupled or positioned adjacent to a touch panel provided with touch sensing circuit and a pressure sensor capable of measuring intensity (pressure) of a touch. For example, as an example of the touch panel, the display 250 may be coupled or positioned adjacent to the touch panel detecting an electromagnetic resonance (EMR) type stylus pen.

According to one or more embodiments, the first area 251 and the second area 252 may have a shape that is generally symmetrical with respect to the folding area 253. However, unlike the first area 251, the second area 252 may include a notch cut according to the presence of the sensor area 222, but may have a symmetrical shape with the first area 251 in other areas. In other words, the first area 251 and the second area 252 may include a portion having a symmetrical shape and a portion having an asymmetrical shape.

According to one or more embodiments, an edge thickness of the first area 251 and the second area 252 may be formed to be different from an edge thickness of the folding area 253. The edge thickness of the folding area 253 may be formed to be thinner than the edge thickness of the first area 251 and the second area 252. In terms of thickness, the first area 251 and the second area 252 may have an asymmetric shape when the first area 251 and the second area 252 are viewed from their cross-sections. For example, the edge of the first area 251 may be formed to have a first radius of curvature, and the edge of the second area 252 may be formed to have a second radius of curvature different from the first radius of curvature. In another embodiment, in terms of thickness, the first area 251 and the second area 252 may have a symmetrical shape when the first area 251 and the second area 252 are viewed from their cross-sections.

Hereinafter, an operation of the first housing structure 210 and the second housing structure 220 and each area of the display 250 according to a status (e.g., a folded status, an unfolded status, or an intermediate status) of the electronic device 200 will be described.

According to one or more embodiments, when the electronic device 200 is in an unfolded status (e.g., FIG. 2), the first housing structure 210 and the second housing structure 220 may be positioned to form an angle of about 180 degrees and face the same direction. An outer surface of the first area 251 and an outer surface of the second area 252 of the display 250 may form about 180 degrees, and may face the same direction (e.g., a front direction of the electronic device). The folding area 253 may form the same flat surface with the first area 251 and the second area 252.

According to one or more embodiments, when the electronic device 200 is in a folded status (e.g., FIG. 3), the first housing structure 210 and the second housing structure 220 may be positioned to face each other. The surface of the first area 251 and the surface of the second area 252 of the display 250 form a narrow angle (e.g., between about 0 and about 10 degrees), and may face each other. At least a portion of the folding area 253 may be formed of a curved surface having a certain curvature.

According to one or more embodiments, when the electronic device 200 is in an intermediate status, the first housing structure 210 and the second housing structure 220 may be positioned with a certain angle from each other. The surface of the first area 251 and the surface of the second area 252 of the display 250 may form an angle larger than that of the folded status and smaller than that of the unfolded status. At least a portion of the folding area 253 may be formed of a curved surface having a certain curvature, and the curvature at this time may be smaller than that in the folded status.

(a) of FIG. 4 may illustrate a fully unfolded status of the electronic device 200, and (b) of FIG. 4 may illustrate an intermediate status in which the electronic device 200 is partially unfolded. As described above, the electronic device 200 may be changed into a folded status or an unfolded status. According to an embodiment, the electronic device 200 may be folded in two ways: ‘in-folding’ in which the front surface of the electronic device 200 is folded to form an acute angle and ‘out-folding’ in which the front surface of the electronic device 200 is folded to form an obtuse angle, when viewed from the folding axis direction (e.g., an A-axis of FIG. 2). For example, while the electronic device 200 is in a folded status in which the electronic device 200 is folded in in-folding manner, the first surface of the first housing structure 210 may face the third surface of the second housing structure 220, and while the electronic device 200 is in a fully unfolded status, the first surface of the first housing structure 210 and the third surface of the second housing structure 220 may face in the same direction (e.g., in a direction parallel to the z-axis).

For example, the second surface of the first housing structure 210 may face the fourth surface of the second housing structure 220 in a state that the electronic device 200 is folded in the out-folding type.

Furthermore, in an embodiment, the electronic device 200 may include a plurality of hinge axes (e.g., two parallel hinge axes from each other, including the A-axis and another axis parallel to the A-axis of FIG. 2). In this case, the electronic device 200 may be folded in a ‘multi-folding’ type in which the in-folding type and out-folding type are combined.

The in-folding type may mean a status in which the display 250 is not exposed to the outside in a fully folded status. The out-folding type may mean a status in which the display 250 is exposed to the outside in a fully folded status. (b) of FIG. 4 illustrates a partially unfolded intermediate status in an in-folding process of the electronic device 200.

Hereinafter, it will be described based on a status in which the electronic device 200 is folded in the in-folding type, but these descriptions may be applied to a status in which the electronic device 200 is folded in the out-folding type.

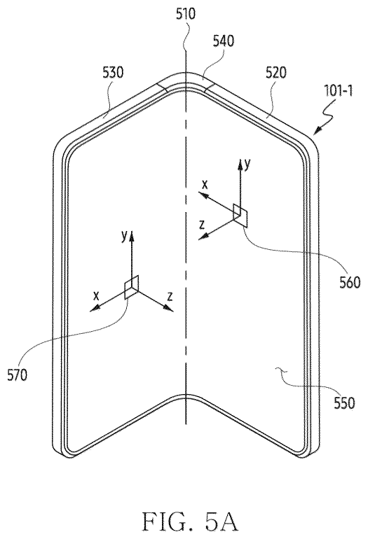

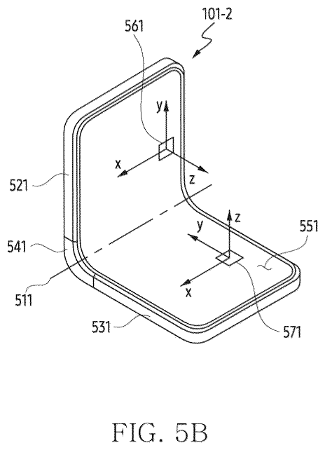

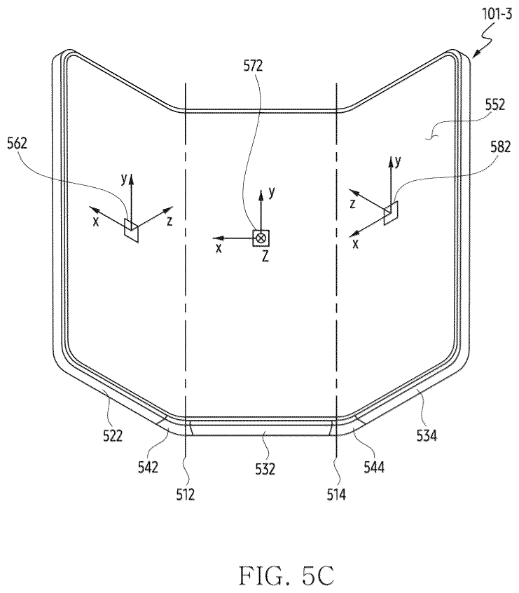

FIGS. 5A to 5C illustrate positions of a plurality of acceleration sensors in an electronic device according to an embodiment. The electronic device of FIGS. 5A to 5C may be an example of the electronic device 101 of FIG. 1 and/or the electronic device 200 of FIGS. 2 to 4.

Referring to FIGS. 5A to 5C, examples of the electronic device divided by a shape and/or a structure of a housing are illustrated. The electronic device of FIGS. 5A to 5C may be a terminal owned by different users. For example, the terminal may include a smart accessory, such as a personal computer (PC) such as a laptop and desktop, a smartphone, a smart pad, a tablet personal computer (a tablet PC), a smartwatch, and a head-mounted device (HMD). The electronic device according to an embodiment may include the housing that is deformable based on at least one folding axes. The number of folding axis in the housing of the electronic device may be one (e.g., a folding axis 510 of FIG. 5A and/or a folding axis 511 of FIG. 5B) or two or more (e.g., folding axes 512 and 514 of FIG. 5C).

Referring to FIG. 5A, a deformable housing of an electronic device 101-1 according to an embodiment may be distinguished by a portion 540 including the folding axis 510 and portions 520 and 530 connected to the portion 540. A display 550 of the electronic device 101-1 according to an embodiment may be a flexible display positioned across the portions 520 and 530.

The electronic device 101-1 according to an embodiment may include acceleration sensors 560 and 570 positioned in each of the portions 520 and 530. The acceleration sensors 560 and 570 may be included in the electronic device 101-1 to measure a shape and/or a posture of the electronic device 101-1. Each of the acceleration sensors 560 and 570 may be included in a six-axis motion sensor including an acceleration sensor based on three axes of the +x-axis, +y-axis, and +z-axis of FIG. 5A, and a gyro sensor based on the three axes. The acceleration sensors 560 and 570 may identify acceleration applied to each of the three axes. The acceleration may be a vector based on a direction and/or magnitude of a net force applied to the electronic device 101-1. For example, the acceleration may be a vector indicating an amount of change in speed of the electronic device 101-1 by the net force. The net force applied to the electronic device 101-1 may include a combination of gravity or another force (e.g., a force applied to the electronic device 101-1 by a user holding the electronic device 101-1) different from the gravity. The acceleration sensors 560 and 570 of the electronic device 101-1 according to an embodiment may identify rotation of the acceleration sensor based on the one or more axes. The electronic device 101-1 according to an embodiment may identify a movement of the electronic device 101-1 based on the acceleration and/or the rotation identified by each of the acceleration sensors 560 and 570.

The electronic device 101-1 according to an embodiment may identify the acceleration of different surfaces (e.g., each of surfaces of the portions 520 and 530) of the housing based on the acceleration sensors 560 and 570. The acceleration measured by the acceleration sensors 560 and 570 dispersed in the surfaces may be changed according to an angle between the surfaces of the electronic device 101-1. For example, when the electronic device 101-1 fell, the acceleration measured by the acceleration sensors 560 and 570 may be changed according to a direction in which the electronic device 101-1 collides with the ground and/or a shape of the electronic device 101-1 in a moment when it collides with the ground. The electronic device 101-1 according to an embodiment may more accurately identify motion (e.g., free fall) of the electronic device 101-1 by the acceleration based on the magnitudes of acceleration differently identified by the acceleration sensors 560 and 570.

The shape of the electronic device 101-1 is not limited to an embodiment of FIG. 5A in which the folding axis 510 is formed parallel to a length from among the width and a length shorter than the width of the display 550. Referring to FIG. 5B, an example of an electronic device 101-2 including a display 551 having a width and a length longer than the width, and a folding axis 511 formed parallel to the width is illustrated. A deformable housing of the electronic device 101-2 may include a portion 541 including the folding axis 511, and portions 521 and 531 distinguished by the folding axis 511. The electronic device 101-2 may include acceleration sensors 561 and 571 positioned in each of the portions 521 and 531. Using the acceleration sensors 561 and 571, the electronic device 101-2 may obtain an angle between the portions 521 and 531 and the folding axis 511. Based on the angle, the electronic device 101-2 may identify a status (e.g., a folded status, an unfolded status, or an intermediate status) of the electronic device 101-2.

In an embodiment, the acceleration sensors 561 and 571 included in the electronic device 101-2 may be positioned on printed circuit boards (PCBs) included in the each of the portions 521 and 531. Among the PCBs, a PCB in which a processor (e.g., the processor 120 of FIG. 1) is positioned may be referred to as a main board. Among the PCBs, another PCB different from a PCB which is a main board, may be referred to as a sub-board. Among the acceleration sensors 561 and 571, an acceleration sensor positioned on the main board may be referred to as a main acceleration sensor (e.g., a main 6-axis acceleration sensor), and another acceleration sensor may be referred to as a sub-acceleration sensor (e.g., a sub-6-axis acceleration sensor).

The number of folding axis 511 of the electronic device 101-2 is not limited to an embodiment of FIGS. 5A to 5B. Referring to FIG. 5C, an example of an electronic device 101-3 including a plurality of folding axes 512 and 514. A deformable housing of the electronic device 101-3 may include a portion 542 including the folding axis 512, a portion 544 including a folding axis 514, a portion 532 connected to the portions 542 and 544, a portion 522 connected to the portion 542, and a portion 534 connected to the portion 544. The electronic device 101-3 may include a display 552 disposed in the portions 522, 532, and 534 across the folding axes 512 and 514.

The electronic device 101-3 according to an embodiment may include acceleration sensors 562, 572, and 582 positioned in each of the portions 522, 532, and 534. Using the acceleration sensors 562, 572, and 582, the electronic device 101-3 may identify an angle at the folding axis 512 (e.g., an angle between the portions 522, 532, and the folding axis 512), and/or an angle at the folding axis 514 (e.g., between the portions 532, 534, and the folding axis 514). Based on the angles, the electronic device 101-3 may identify a shape and/or a posture of the electronic device 101-3.

As described above, the electronic device according to an embodiment may include a plurality of acceleration sensors for identifying a shape and/or a posture of the deformable housing. In an embodiment of FIGS. 5A to 5C in which the electronic device includes the deformable housing, acceleration measured by acceleration sensors (e.g., the acceleration sensors 560, 561, 562, 571, 572, and 582) positioned in distinct portions (e.g., the portions 520, 521, 522, and 534) of the deformable housing may be different. For example, as the portions in which the acceleration sensors are positioned move or rotate differently according to a shape of the electronic device, the acceleration measured by the acceleration sensors may be different. For example, while the electronic device is moving, such as free fall, the electronic device may obtain different acceleration from the acceleration sensors. The electronic device according to an embodiment may more accurately identify motion (e.g., free fall) of the electronic device based on the different acceleration obtained from the acceleration sensors. For example, while the electronic device is falling, such as free fall, the electronic device may more accurately obtain information (e.g., at least one of a distance, duration that the electronic device is moved, or an impulse applied to the electronic device) related to the free fall of the electronic device based on the different acceleration obtained from the acceleration sensors.

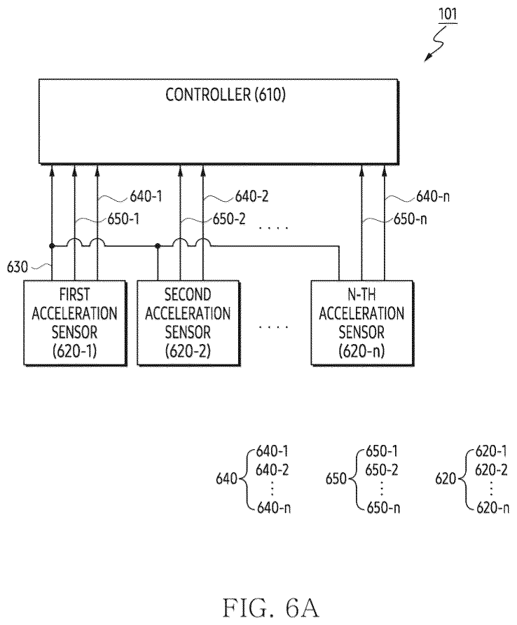

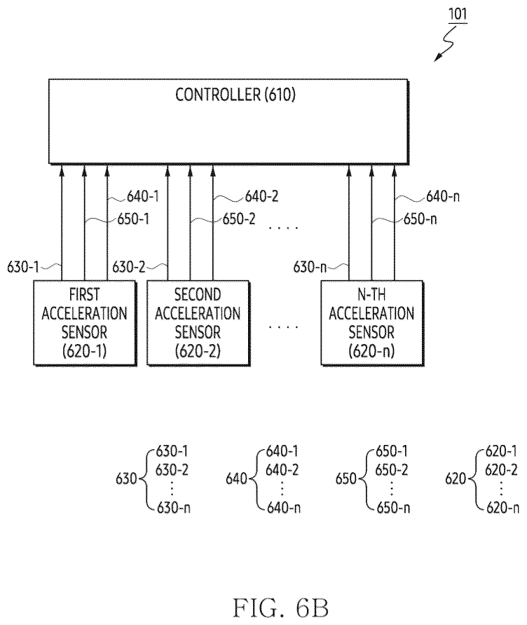

Hereinafter, an example structure for the electronic device according to an embodiment for obtaining information related to motion (e.g., free fall) of the electronic device from a plurality of acceleration sensors will be described with reference to FIGS. 6A to 6B.

FIGS. 6A to 6B illustrate example block diagrams of a plurality of acceleration sensors 620 and a controller 610 of an electronic device 101 according to an embodiment. The electronic device 101 of FIGS. 6A to 6B may include the electronic device 101 of FIG. 1, the electronic device 200 of FIGS. 2 to 4, and the electronic devices 101-1, 101-2, 101-3 of FIGS. 5A to 5C.

In some embodiments, the controller 610 may correspond to one or more processors. The one or more processors may include one or more of a central processing unit (CPU), a graphics processing unit (GPU), an accelerated processing unit (APU), a many integrated core (MIC), a field-programmable gate array (FPGA), a digital signal processor (DSP), a neural processing unit (NPU), a hardware accelerator, or a machine learning accelerator. The one or more processors are able to perform control of any one or any combination of the other components of the computing device, and/or perform an operation or data processing relating to communication. The one or more processors execute one or more programs stored in a memory.

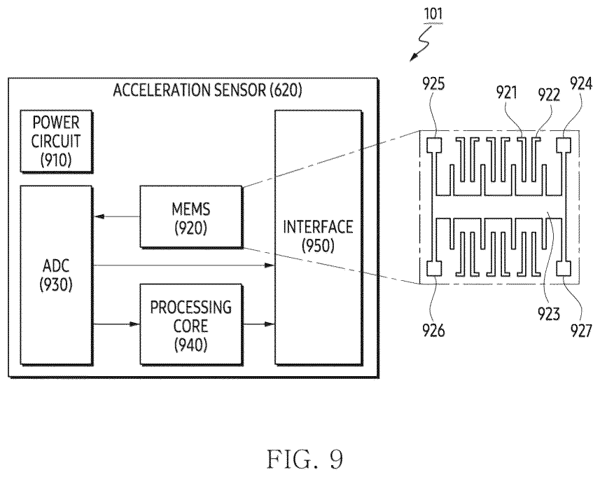

Referring to FIGS. 6A to 6B, the electronic device 101 according to an embodiment may include a plurality of acceleration sensors 620. Referring to FIGS. 6A to 6B, as an example of the plurality of acceleration sensors 620, “n” acceleration sensors (e.g., a first acceleration sensor 620-1, a second acceleration sensor 620-2, and a n-th acceleration sensor 620-n) are illustrated. “n” is a number that is larger than or equal to one (1). The plurality of acceleration sensors 620 may be positioned in different portions of a housing distinguished by at least one folding axis in the electronic device 101, such as the acceleration sensors 560, 561, 562, 570, 572, and 582 of FIGS. 5A to 5C. A structure of the plurality of acceleration sensors 620 according to an embodiment will be described with reference to FIG. 9.

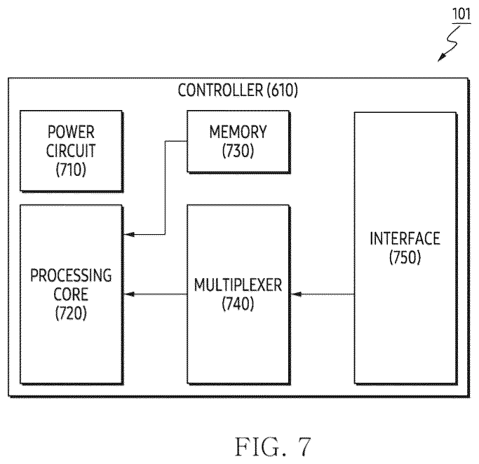

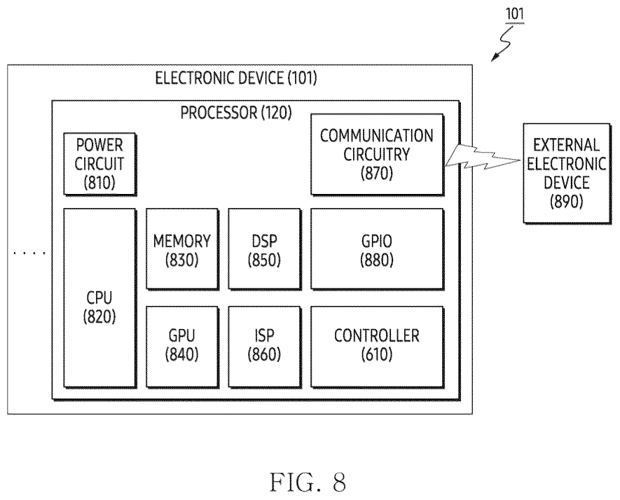

Referring to FIGS. 6A to 6B, the electronic device 101 according to an embodiment may include the controller 610 electrically and/or operably coupled to the plurality of acceleration sensors 620. The controller 610 may be included in the processor 120 of FIG. 1, or may be included in the micro controller unit (MCU) of the sensor module 176 of FIG. 1. The controller 610 may be referred to as a master of the plurality of acceleration sensors 620. Referring to FIGS. 6A to 6B, signal paths 630, 640, and 650 between the controller 610 and the plurality of acceleration sensors 620 are illustrated. The signal paths 630, 640, and 650 may be included in a communication bus of the electronic device 101. The communication bus may be formed in the electronic device 101 to support transmission of digital signals through one or more conductive wires formed in the electronic device 101. The signal paths 630, 640, and 650 may be formed on hardware for electrically connecting the controller 610 and the plurality of acceleration sensors 620, such as a flexible PCB (FPCB). A structure of the controller 610 according to an embodiment will be described with reference to FIGS. 7 to 8.

The controller 610 of the electronic device 101 according to an embodiment may identify an angle of the housing according to a folding of the housing based on the plurality of acceleration sensors 620. The controller 610 may receive a data signal indicating acceleration identified in each of the plurality of acceleration sensors 620 from the plurality of acceleration sensors 620 by using the signal path 630. The controller 610 may receive a data signal indicating angular velocity identified in each of the plurality of acceleration sensors 620 from the plurality of acceleration sensors 620 by using the signal path 630. Based on the data signal indicating the acceleration and/or the angular velocity, the controller 610 may identify a shape of the electronic device 101 (e.g., the angle between the folding axis 510 and the portions 520, 530, of FIG. 5A). The signal path 630 may be formed in the electronic device 101 to support the transmission of a data signal from any one of the plurality of acceleration sensors 620 to the controller 610, based on a serial peripheral interface (SPI), inter-integrated circuit (I2C) (or two-wire interface (TWI)), and/or a universal asynchronous receiver/transmitter (UART).

The number of signal paths 630 for exchanging a data signal between the plurality of acceleration sensors 620 and the controller 610 is not limited to an embodiment of FIG. 6A in which one signal path 630 is formed between a plurality of acceleration sensors 620 and the controller 610. Referring to FIG. 6B, the electronic device 101 according to an embodiment may include a signal path 630-1 formed for an exchange of data signals between the first acceleration sensor 620-1 and the controller 610, and a signal path 630-2, different from the signal path 630-1, formed for an exchange of data signals between the second acceleration sensor 620-2 and the controller 610. Referring to FIG. 6B, according to an embodiment, the electronic device 101 may include signal paths (e.g., the signal path 630-1 for exchanging data signals between the first acceleration sensor 620-1 and the controller 610, a signal path 630-2 for exchanging data signals between the second acceleration sensor 620-2 and the controller 610, and a signal path 630-n between the n-th acceleration sensor 620-n and the controller 610) for individually transmitting data signals of the plurality of acceleration sensor 620 to the controller 610.

The plurality of acceleration sensors 620 of the electronic device 101 according to an embodiment may identify that the electronic device 101 fell by acceleration of gravity based on whether magnitude of acceleration is decreased to less than a first threshold (e.g., about 0.1 g) less than the magnitude (e.g., about 9.8 m/s², or about 1 g) of the acceleration of gravity. For example, based on the identification of the acceleration having magnitude less than the first threshold for preset duration, the plurality of acceleration sensors 620 may identify the fall of electronic device 101. The plurality of acceleration sensors 620 may transmit an interrupt signal for notifying the fall to the controller 610 in response to identifying the fall. The interrupt signal may be transmitted to the controller 610 through signal paths 640 different from the signal path 630 for transmission of the data signals.

Referring to FIGS. 6A to 6B, the electronic device 101 according to an embodiment may include a plurality of signal paths 640 for transmitting an interrupt signal of each of the plurality of acceleration sensors 620 to the controller 610. For example, a signal path 640-1 may connect the first acceleration sensor 620-1 and the controller 610. For example, a signal path 640-2 may connect the second acceleration sensor 620-2 and the controller 610. Since the signal paths 640 for transmitting the interrupt signal are individually formed between the controller 610 and all of the plurality of acceleration sensors 620, the controller 610 according to an embodiment may receive interrupt signals transmitted from the each of the plurality of acceleration sensors 620.

The electronic device 101 according to an embodiment may include signal paths 650 for transmitting a signal (e.g., a data ready signal) notifying (or indicating) that the plurality of acceleration sensors 620 are ready to transmit a data signal through the signal path 630. For example, the signal path 650-1 may be formed between the first acceleration sensor 620-1 to the controller 610 for transmission of a signal to notify that the data signal is ready to be transmitted from the first acceleration sensor 620-1 to the controller 610. For example, the signal path 650-2 may be connected to the second acceleration sensor 620-2 and the controller 610. A data ready signal transmitted by the second acceleration sensor 620-2 may be transmitted to the controller 610 through the signal path 650-2. The signal paths 650 may be omitted according to an embodiment.

The plurality of acceleration sensors 620 of the electronic device 101 according to an embodiment may identify acceleration based on a preset cycle (e.g., a cycle corresponding to frequency about 416 Hz). Each of the plurality of acceleration sensors 620 may identify free fall of the electronic device 101 based on magnitude of acceleration indicated along axes (e.g., the six axes) perpendicular to each other. For example, the first acceleration sensor 620-1 may identify the magnitude of acceleration based on Equation 1, from the acceleration measured based on three axes, such as x, y, z.

$$\sqrt{{x}^{2} + {y}^{2} + {z}^{2}} \qquad [ Equation 1 ]$$

The magnitude of acceleration of [Equation 1] may be referred to as a length of the acceleration. When a movement of the electronic device 101 is ceased, the magnitude of acceleration identified based on [Equation 1] may be matched to the magnitude of the acceleration of gravity. When the electronic device 101 is moved by the acceleration of gravity, such as free fall, the magnitude of acceleration identified based on [Equation 1] may become zero or may be approximated to zero.

According to an embodiment, the plurality of acceleration sensors 620 may identify that the electronic device 101 fell when the magnitude of acceleration identified based on [Equation 1] becomes zero (0) for preset duration (e.g., duration that is a multiplier of the duration, corresponding to frequency of about 416 Hz). An example of the multiplier is 8 times.

After identifying that the electronic device 101 is falling, the plurality of acceleration sensors 620 may identify duration that the electronic device 101 is falling based on a preset moment. For example, the plurality of acceleration sensors 620 may identify acceleration at each moment, at the same time gradually increase parameters (e.g., a counter) for identifying the duration. When the magnitude of acceleration identified at each preset moment increases to a threshold (e.g., about 0.5 g to about 4 g) exceeding 0, the plurality of acceleration sensors 620 may identify that the electronic device 101 ceases falling. Based on the identification of the ceasing of the fall, the plurality of acceleration sensors 620 may cease the gradual increase in the parameter. Based on the identification of the ceasing of the fall, the plurality of acceleration sensors 620 may transmit interrupt signals to the controller 610.

The plurality of acceleration sensors 620 of the electronic device 101 according to an embodiment may track or monitor the magnitude of acceleration in a time section from a first moment identifying the ceasing of the fall of the electronic device 101 to a second moment that the magnitude of acceleration applied to the electronic device 101 converges to the magnitude of the acceleration of gravity. The first moment may be a moment when the electronic device 101 collides with the ground by the fall. In the time section between the first moment and the second moment, an additional movement of the electronic device 101 may occur by the collision between the electronic device 101 and the ground. The second moment may be a moment when the additional movement is ceased. The electronic device 101 according to an embodiment may identify a representative value (e.g., a maximum value, minimum value, intermediate value, mode value, or average value) of an impulse applied to the electronic device 101 in the time section by using the data signals received from the plurality of acceleration sensors 620. The electronic device 101 according to an embodiment may identify a shape (e.g., the angle between the folding axis 510 of FIG. 5A and the portions 520 and 530) of the electronic device 101 in the moment when the electronic device 101 collides with the ground by the fall.

In an embodiment, the plurality of acceleration sensors 620 may store acceleration repeatedly measured according to a preset moment after the first moment in each memory of the plurality of acceleration sensors 620. The plurality of acceleration sensors 620 may identify that the movement of the electronic device 101 by the collision between the electronic device 101 and the ground is ceased based on repeatedly identifying the acceleration having magnitude of the acceleration of gravity for a preset duration (e.g., duration between the preset moments). The plurality of acceleration sensors 620 may obtain, based on the identification of the second moment at which the movement of the electronic device 101 is ceased, the representative value of the impulse applied to the electronic device 101 in the time section between the first moment and the second moment, based on the acceleration stored in the memory.

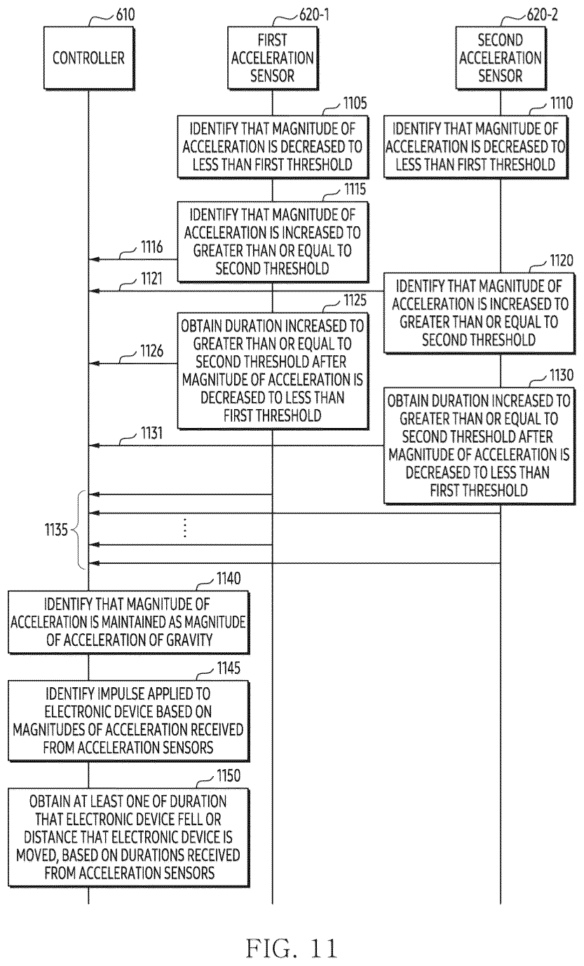

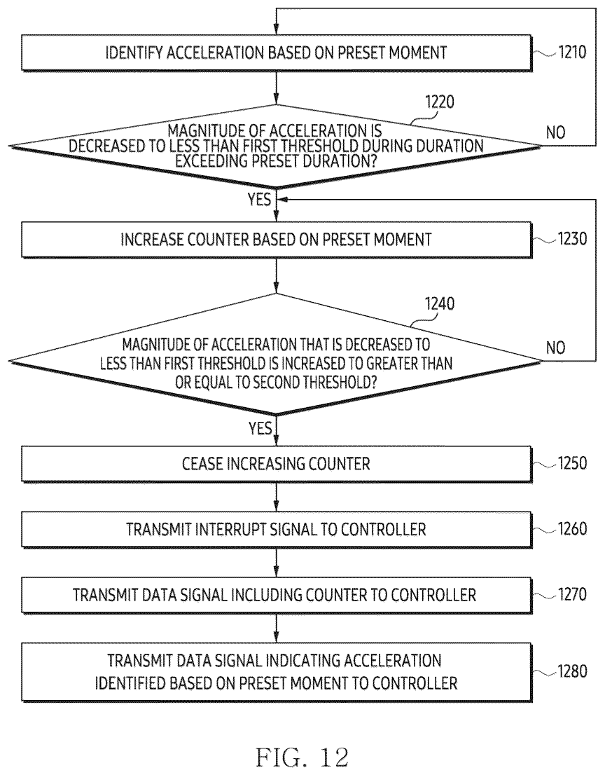

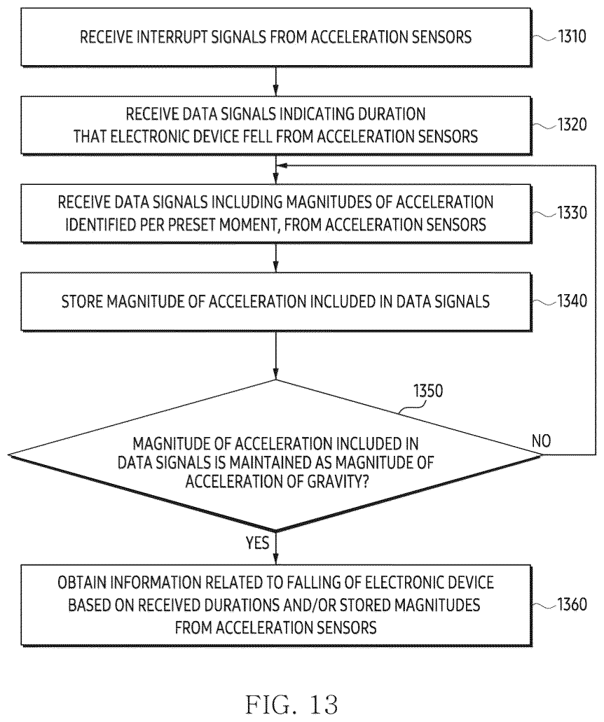

The plurality of acceleration sensors 620 according to an embodiment may transmit data signals including at least one of information indicating the time section, or the impulse, to the controller 610. The plurality of acceleration sensors 620 according to an embodiment may transmit data signals indicating acceleration which is repeatedly measured according to the preset moment to the controller 610 in the time section. The plurality of acceleration sensors 620 according to an embodiment may transmit data signals indicating a representative value (e.g., a maximum value, minimum value, intermediate value, mode value, and/or average value of the magnitudes) of the magnitudes of acceleration repeatedly measured according to the preset moment in the time section to the controller 610. The plurality of acceleration sensors 620 according to an embodiment may transmit a data signal indicating duration that the electronic device 101 fell to the controller 610 from at least one of the first moment or the second moment. For example, the data signal may include a numeric value stored in the parameter and/or the counter. An operation in which the plurality of acceleration sensors 620 transmit an interrupt signal and/or a data signal to the controller 610 will be described with reference to FIGS. 11 and 12, and/or 14 and 15. An operation of the controller 610 receiving the interrupt signal and/or the data signal will be described with reference to FIGS. 13 and/or 16 to 17.

As described above, the controller 610 of the electronic device 101 according to an embodiment may receive interrupt signals from each of the plurality of acceleration sensors 620 by using the signal paths 640. Since the controller 610 receives the interrupt signals, based on the received interrupt signals, the controller 610 may receive data signals from the plurality of acceleration sensors 620 after the interrupt signals. Based on the data signals, the controller 610 may obtain information related to the fall of the electronic device 101 (e.g., at least one of duration that the electronic device 101 fell, a distance that the electronic device 101 was moved, or an impulse applied to the electronic device 101). For example, the electronic device 101 may more accurately identify motion (e.g., the motion of the electronic device 101 based on the acceleration of gravity such as free fall) of the electronic device 101 by comprehensively processing the data signals received from all of the plurality of acceleration sensors 620. Since the motion is more accurately identified, the electronic device 101 may more accurately identify damage (e.g., impulse) of the electronic device 101 caused by the motion.

Hereinafter, a structure of one or more hardware in the controller 610 of the electronic device 101 according to an embodiment will be described with reference to FIG. 7.

FIG. 7 illustrates an example block diagram of a controller 610 configured to control a plurality of acceleration sensors of an electronic device 101 according to an embodiment.

The electronic device 101 of FIG. 7 may be an example of the electronic device 101 of FIGS. 6A to 6B. For example, the plurality of acceleration sensors may be an example of the plurality of acceleration sensors 620 of FIGS. 6A to 6B. For example, the controller 610 of FIGS. 6A to 6B may include the controller 610 of FIG. 7.

Referring to FIG. 7, the controller 610 may include at least one of a power circuit 710, a processing core 720, a memory 730, a multiplexer 740, or an interface 750. The power circuit 710 in the controller 610 may include a circuit (e.g., a buck converter, and/or a boost converter) for generating a power signal having voltage required by another circuit in the controller 610 (e.g., at least one of the processing core 720, the memory 730, the multiplexer 740, or the interface 750).

Referring to FIG. 7, the controller 610 may be connected to other hardware (e.g., the plurality of acceleration sensors 620 of FIGS. 6A to 6B, and/or the processor 120 of FIG. 1) in the electronic device 101 different from the controller 610 through the interface 750. For example, the interface 750 may be connected to a plurality of acceleration sensors in the electronic device 101 through the signal paths 630, 640, and 650 of FIGS. 6A to 6B. The controller 610 may be connected not only to an inertia measurement unit (IMU) sensor such as an acceleration sensor, but also to another sensor (e.g., a proximity sensor and/or an illuminance sensor) different from the IMU sensor. The multiplexer 740 may adjust an electrical connection between sensors connected to the controller 610 and the processing core 720 by changing an electrical connection between the interface 750 and the processing core 720.

The processing core 720 of the controller 610 according to an embodiment may process a signal (e.g., an interrupt signal, and/or a data signal) received from sensors connected to the controller 610. For example, the processing core 720 may identify a fall of the electronic device 101 based on the interrupt signal received from the plurality of acceleration sensors. Based on identifying the fall, the processing core 720 may process the data signal received from the plurality of acceleration sensors to obtain information for indicating the motion of the electronic device 101 by the fall. The information may include, for example, at least one of a distance that the electronic device 101 is moved by the fall, duration that the electronic device 101 is moved by the fall, or an impulse applied to the electronic device 101. The processing core 720 may transmit the information to the processor 120 of FIG. 1 and/or an external electronic device (e.g., the electronic device 102, the electronic device 104, and/or the server 108 of FIG. 1). The information transmitted from the processing core 720 may be used to identify damage (e.g., impulse) of the electronic device 101 by the fall.

The memory 730 of the controller 610 according to an embodiment may store the information processed by the processing core 720. For example, the memory 730 may include an electrically erasable programmable read-only memory (EEPROM). Acceleration included in data signals received from the plurality of acceleration sensors, or the magnitude of acceleration may be accumulated in the memory 730. Based on the magnitudes accumulated in the memory 730, the processing core 720 may identify a representative value of the impulse applied to the electronic device 101. Durations that the electronic device 101 fell, identified from the data signals received from the plurality of acceleration sensors, may be stored in the memory 730. Based on the representative value (e.g., an average value, maximum value, minimum value, mode value, and/or intermediate value of the durations) of the durations stored in the memory 730, the processing core 720 may identify duration that the electronic device 101 fell.

The controller 610 in the electronic device 101 according to an embodiment may be positioned on a PCB (e.g., a main board) of the electronic device 101 or positioned in a processor (e.g., the processor 120 of FIG. 1) of the electronic device 101 in order to form a system on a chip (SoC) together with the processor. Hereinafter, an embodiment in which the controller 610 of the electronic device 101 according to an embodiment is included in the processor will be described with reference to FIG. 8.

FIG. 8 illustrates an example block diagram of a processor 120 configured to control a plurality of acceleration sensors of an electronic device 101 according to an embodiment. The electronic device 101 of FIG. 8 may be an example of the electronic device 101 of FIGS. 6A to 6B and/or FIG. 7. For example, the plurality of acceleration sensors may be an example of the plurality of acceleration sensors 620 of FIGS. 6A to 6B. For example, the controller 610 of FIG. 8 may include the controller 610 of FIG. 6A to FIG. 6B and/or FIG. 7.

Referring to FIG. 8, the processor 120 may include at least one of a power circuit 810, a central processing unit (CPU) 820, a memory 830, a graphic processing unit (GPU) 840, a digital signal processor (DSP) 850, an image signal processor (ISP) 860, communication circuitry 870, a general purpose input/output (GPIO) 880, or the controller 610. The processor 120 may be referred to as an application processor (AP). The power circuit 810 in the processor 120 may include a circuit for generating DC voltage for driving another circuit (e.g., the memory 830, GPU 840, DSP 850, ISP 860, communication circuitry 870, GPIO 880, and controller 610) in the processor 120, such as a buck converter and/or a boost converter.

The processor 120 of the electronic device 101 according to an embodiment may be configured with a plurality of processor modules (e.g., a first processor module and a second processor module), and each of the plurality of processor modules may be partially divided into arbitrary data operation or data processing.

Referring to FIG. 8, the CPU 820 of the processor 120 may execute one or more functions related to the electronic device 101 based on instructions stored in the memory 830. The GPU 840 of the processor 120 may execute the one or more functions for rendering a graphic object to be displayed on a display (e.g., the displays 550, 551, 552 of FIGS. 5A to 5C) of the electronic device 101. The DSP 850 of the processor 120 may execute one or more functions for processing a digital signal. The ISP 860 of the processor 120 may execute one or more functions for processing an image and/or video captured by an image sensor (e.g., the camera module 180 of FIG. 1). The communication circuitry 870 of the processor 120 may support communication between the electronic device 101 and an external electronic device 890 (e.g., the electronic device 102, the electronic device 104, and/or the server 108 of FIG. 1) based on wired communication and/or wireless communication. The GPIO 880 of the processor 120 may support communication between the processor 120 and other hardware (e.g., the plurality of acceleration sensors 620 of FIGS. 6A to 6B) within the electronic device 101. The controller 610 in the processor 120 of FIG. 8 may include a circuit (e.g., at least one of the processing core 720, the memory 730, the multiplexer 740, and the interface 750) in the controller 610 of FIG. 7.

According to an embodiment, the processor 120 of the electronic device 101 may obtain information related to motion (e.g., free fall) of the electronic device 101 based on interrupt signals and/or data signals obtained from a plurality of acceleration sensors (e.g., the acceleration sensors 620 of FIGS. 6A to 6B). For example, the processor 120 may identify at least one of a distance, duration that the electronic device 101 fell, a shape of the electronic device 101, or an impulse applied to the electronic device 101. The CPU 820 may execute a function for displaying information related to the fall of the electronic device 101 based on the obtained information. For example, the CPU 820 may transmit the obtained information to the external electronic device 890 by using the communication circuitry 870. The external electronic device 890 may store information transmitted from a plurality of terminals including the electronic device 101. For example, CPU 820 may display a user interface (UI) related to the information on the display (e.g., the displays 550, 551, and 552 of FIGS. 5A to 5C) of electronic device 101. The UI may include a pop-up window in which preset text (e.g., “A fall of the terminal detected. Visit the service center”) is displayed. The preset text may include a natural language sentence requesting a diagnosis of the electronic device 101. In an embodiment, based on the information related to the motion of the electronic device 101 such as free fall, the CPU 820 in the electronic device 101 may display at least one of a screen, haptic feedback (e.g., vibration), or an audio signal requesting the diagnosis of the electronic device 101.

The processor 120 of the electronic device 101 according to an embodiment may be connected to a plurality of acceleration sensors in the electronic device 101 through the controller 610. The processor 120 and the plurality of acceleration sensors may be connected by signal paths for individually receiving interrupt signals of each of the plurality of acceleration sensors, such as the signal paths 640 of FIGS. 6A to 6B. The processor 120 may extract information related to the fall of the electronic device 101, stored in the data signals received from the plurality of acceleration sensors, based on receiving the interrupt signals for notifying the fall of the electronic device 101 from the plurality of acceleration sensors. Based on the information extracted from the plurality of acceleration sensors, the processor 120 may reduce an error included in the data signals of the plurality of acceleration sensors. Based on the reduced error, the processor 120 may more accurately identify information related to the fall (e.g., at least one of the duration, distance that the electronic device 101 fell, or the impulse applied to the electronic device 101).

As described above, the electronic device 101 may include the plurality of acceleration sensors and the controller 610 (or the processor 120) connected to the plurality of acceleration sensors. The plurality of acceleration sensors may be dispersed into distinct portions (e.g., portions distinguished by a folding axis of the deformable housing) of the deformable housing of the electronic device 101. The plurality of acceleration sensors may identify different acceleration in a substantially matched moment by a position of the plurality of acceleration sensors in the electronic device 101 and/or a deformation of the deformable housing. The processor 120 of the electronic device 101 according to an embodiment may obtain information related to the fall of the electronic device 101 from the different acceleration. The obtained information may notify a user of the electronic device 101 of information (e.g., the impulse) for identifying damage of the electronic device 101, or transmit information for collecting durability of the electronic device 101 to the external electronic device 890.

Hereinafter, a structure of each of the plurality of acceleration sensors in the electronic device 101 connected to the processor 120 and/or the controller 610 will be described with reference to FIG. 9.

FIG. 9 illustrates a block diagram of any one of a plurality of acceleration sensors 620 of an electronic device 101 according to an embodiment. The electronic device 101 of FIG. 9 may be an example of the electronic device 101 of FIGS. 6A to 6B and/or FIG. 8. For example, the acceleration sensor 620 of FIG. 9 may be an example of the plurality of acceleration sensors 620 of FIGS. 6A to 6B.

Referring to FIG. 9, the acceleration sensor 620 may include at least one of a power circuit 910, micro electro mechanical systems (MEMS) 920, an analog-to-digital converter (ADC) 930, a processing core 940, or an interface 950. The power circuit 910 in the acceleration sensor 620 may include a circuit (e.g., a buck-converter, and/or a boost-converter) for transmitting a power signal to another circuit (e.g., MEMS 920, ADC 930, processing core 940, and/or interface 950) in the acceleration sensor 620. The acceleration sensor 620 may be connected to other hardware in the electronic device 101, such as the d 610 of FIGS. 6A to 6B through the interface 950. The interface 950 may be connected to the signal paths 630, 640, and 650 of FIGS. 6A to 6B.

Referring to FIG. 9, an example of a structure of the MEMS 920 is illustrated. The MEMS 920 may include electrodes 921, 922 and a member 923 having a seismic mass. The member 923 may be connected to the acceleration sensor 620 and/or a housing of the electronic device 101 by points 924, 925, 926, and 927. The member 923 may be deformed by a force applied to the acceleration sensor 620. In an embodiment in which the member 923 includes a metal, deformation of the member 923 may cause deformation of an electric field and/or a magnetic field measured by the electrodes 921 and 922. The acceleration sensor 620 may identify a force (e.g., gravity) applied to the member 923 based on the deformation of the electric field and/or the magnetic field measured by the MEMS 920. The acceleration sensor 620 may output a data signal indicating acceleration of the member 923 caused by the identified force. For example, the electric field and/or the magnetic field measured in the electrodes 921 and 922 may be analog-to-digital converted or filtered by ADC 930 and transmitted to interface 950 and processing core 940. Data transmitted from the ADC 930 to the interface 950 may indicate acceleration measured along a plurality of axes perpendicular to each other and repeatedly measured along a preset moment. For example, the data transmitted from ADC 930 to interface 950 may be included in a data signal transmitted from the acceleration sensor 620 to the controller (e.g., the controller 610 of FIGS. 6A to 6B).

The processing core 940 of the acceleration sensor 620 according to an embodiment may generate an interrupt signal based on the data received from the ADC 930, or obtain an impulse applied to the electronic device 101 by accumulating the data. For example, the processing core 940 may gradually increase a parameter (or counter) for measuring duration that the electronic device 101 was moved by free fall from a first moment when acceleration converted into a digital value by ADC 930 is reduced to less than a first preset threshold for detecting the free fall during the preset duration. For example, the processing core 940 may cease gradually increasing the parameter (or counter) in a second moment when the acceleration outputted from the ADC 930 is increased to greater than or equal to a second preset threshold after the first moment. For example, between the first moment and the second moment, the processing core 940 may repeatedly output a data signal indicating the acceleration identified by the MEMS 920 to the controller through the interface 950 along the preset moment. For example, processing core 940 may store the magnitude of acceleration outputted by the ADC 930 from the second moment to a third moment when the magnitude of acceleration measured by the ADC 930 is maintained as magnitude of acceleration of gravity during preset duration. After the third moment, the processing core 940 may output a representative value (e.g., a maximum value) of the stored magnitudes of acceleration to the controller through the interface 950.

As described above, a plurality of acceleration sensors (e.g., the acceleration sensor 620) in the electronic device 101 according to an embodiment may be positioned in distinct portions of the electronic device 101 (e.g., portions of an interconnected housing by a folding axis) to output information (e.g., acceleration) indicating motion of each of the portion. According to an embodiment, the electronic device 101 may detect preset motion of the electronic device 101 such as free fall by using the acceleration sensor 620. In an embodiment in which the electronic device 101 includes the plurality of acceleration sensors, the electronic device 101 may receive interrupt signals and/or data signals related to the preset motion from all of the plurality of acceleration sensors. Based on the interrupt signals and/or the data signals, the electronic device 101 may more accurately obtain information for identifying damage (e.g., damage by an impulse) of the electronic device 101 by the preset motion. The information may include, for example, at least one of a distance, duration that the electronic device 101 is moved based on the free fall, or an impulse applied to the electronic device 101.

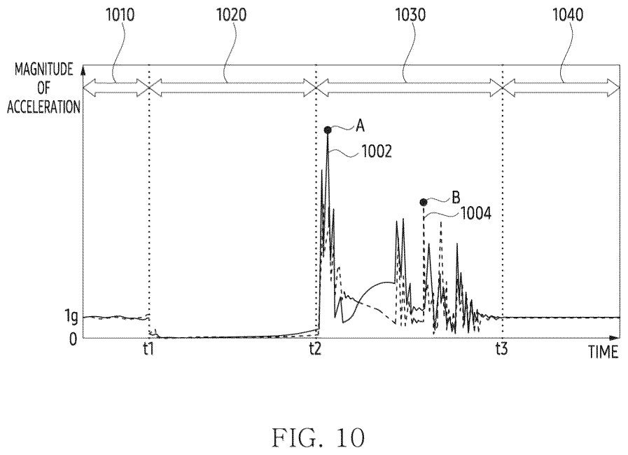

Hereinafter, referring to FIG. 10, an operation in which the electronic device 101 including the plurality of acceleration sensors 620 of FIG. 9 obtains information related to motion of the electronic device 101 including free fall by using a plurality of acceleration sensors will be described.

FIG. 10 illustrates an example graph of magnitudes of acceleration measured by a plurality of acceleration sensors of an electronic device according to an embodiment. The electronic device of FIG. 10 may be an example of the electronic device 101 of FIGS. 6A to 6B and 7 to 9. For example, the acceleration sensors may be an example of the acceleration sensors 620 of FIGS. 6A to 6B.

Referring to FIG. 10, graphs 1002 and 1004 illustrating magnitudes of acceleration obtained from each of a plurality of acceleration sensors according to a time domain are illustrated. For example, the graph 1002 may indicate the magnitude of acceleration in which a first acceleration sensor (e.g., a main 6-axis acceleration sensor) from among the plurality of acceleration sensors repeatedly identifies, based on a preset moment. For example, the graph 1004 may indicate the magnitude of acceleration in which a second acceleration sensor (e.g., a sub-6 axis acceleration sensor) from among the plurality of acceleration sensors repeatedly identifies, based on the preset moment. An x-axis of the graphs 1002 and 1004 may indicate a time axis, and a y-axis may indicate magnitude of acceleration based on Equation 1. Hereinafter, an operation in which the electronic device according to an embodiment processes acceleration measured by the plurality of acceleration sensors based on motion of the electronic device distinguished along first time section 1010 to a fourth time section 1040 will be described.

In the first time section 1010 of FIG. 10, a state of the electronic device may be included in a steady state in which the electronic device does not move. In the first time section 1010, the magnitude of acceleration received from the plurality of acceleration sensors may be maintained as magnitude (e.g., about 1 g) of acceleration of gravity. Referring to FIG. 10, it is assumed that falling of the electronic device starts in a moment t1 between the first time section 1010 and a second time section 1020. In the second time section 1020, the state of the electronic device may be included in a state in which the electronic device fell.

Referring to FIG. 10, the plurality of acceleration sensors may detect the falling of the electronic device in response to an identification of acceleration having magnitude substantially converged to 0 after the moment t1. For example, the plurality of acceleration sensors may determine that the electronic device has begun to fall in response to identifying acceleration less than a first threshold (e.g., about 0.2 g to about 0.5 g) less than magnitude of acceleration of gravity during preset duration (e.g., a multiplier of a preset cycle). After detecting the falling of the electronic device, the plurality of acceleration sensors may identify duration that the electronic device fell, based on a gradually increasing counter. For example, when repeatedly increasing the counter according to the preset cycle, the duration that the electronic device fell may be indicated by multiplication of the preset cycle and the increased counter.

The electronic device may collide with an external object (e.g., the ground) in a moment t2 after the moment t1 when the falling of the electronic device starts. A change in momentum of the electronic device by the collision may be referred to as an impulse applied to the electronic device. The change in momentum may cause a change in acceleration measured by the plurality of acceleration sensors in the electronic device. Referring to FIG. 10, the magnitude of acceleration measured by the plurality of acceleration sensors may be increased to a second threshold or more in the moment t2. The second threshold may be matched to the first threshold for detecting the start of the falling of the electronic device, or may be set independently with the first threshold. Based on the identification of the acceleration increased to greater than or equal to the second threshold, the plurality of acceleration sensors may cease the gradual increase of the counter. Since the increase of the counter starts from the moment t1 when the start of the fall of the electronic device is detected and ceases in the moment t2, a numerical value stored in the counter may be approximated or matched to a length of the second time section 1020 between the moment t1 and the moment t2. For example, the electronic device may be moved based on free fall in the second time section 1020.

Referring to FIG. 10, the plurality of acceleration sensors may track a change of the magnitude of acceleration according to the preset moment in a third time section 1030 after the time point t2 when the falling of the electronic device ceases. Since the plurality of acceleration sensors are included in distinct portions of a deformable housing of the electronic device, the acceleration identified by the plurality of acceleration sensors may be changed by motion and/or rotation of the portions. The plurality of acceleration sensors may accumulate the magnitudes of acceleration in memories (e.g., a cache memory and/or a register in the processing core 940 of FIG. 9) of the plurality of acceleration sensors after the moment t2. The plurality of acceleration sensors may store magnitudes of repeatedly identified acceleration according to the moment in the memory, based on a stack, a queue, a linked list and/or a binary tree.

The plurality of acceleration sensors according to an embodiment may identify whether the magnitude of acceleration repeatedly measured according to the preset moment after the moment t2 is maintained as the magnitude (e.g., about 1 g) of the acceleration of gravity. Referring to FIG. 10, the plurality of acceleration sensors may identify that the magnitude of acceleration is maintained as the magnitude of the acceleration of gravity during the preset duration in the moment t3 after the moment t2. Based on identifying that the magnitude of acceleration is maintained as the magnitude of the acceleration of gravity during the preset duration in the moment t3, the plurality of acceleration sensors may identify that the state of the electronic device is included in the steady state of the first time section 1010. In an embodiment, the plurality of acceleration sensors may cease accumulating the magnitudes of acceleration in the memory, based on identifying that the state of the electronic device is included in the steady state. The plurality of acceleration sensors may transmit data signals including a representative value (e.g., a maximum value) of the magnitudes accumulated in the memory to a controller (e.g., the controller 610 of FIGS. 6A to 6B) connected to the plurality of acceleration sensors. Referring to FIG. 10, a first acceleration sensor may transmit a data signal indicating magnitude of acceleration of a point A within the third time section 1030 of the graph 1002 to the controller. A second acceleration sensor may transmit a data signal indicating magnitude of acceleration of a point B within the third time section 1030 of the graph 1004 to the controller.

The plurality of acceleration sensors may transmit interrupt signals to the controller based on identifying the moment t2 when the falling of the electronic device ceases. In an embodiment, the plurality of acceleration sensors may transmit the interrupt signals to the controller as soon as the moment t2 is identified. In an embodiment, the plurality of acceleration sensors may transmit the interrupt signals to the controller, based on identifying that the magnitude of acceleration is substantially maintained as the magnitude of the acceleration of gravity (e.g., the moment t3). After transmitting the interrupt signals, the plurality of acceleration sensors may transmit data signals indicating duration of the second time section 1020 in which the electronic device fell, to the controller. The controller may identify the duration of the second time section 1020, based on a representative value (e.g., a maximum value, minimum value, intermediate value, mode value, and/or average value) of durations included in each of the data signals received from the plurality of acceleration sensors. The duration of the second time section 1020 may be duration that the electronic device is moved based on free fall.

In an embodiment, the plurality of acceleration sensors transmitting the interrupt signals in the moment t2 may transmit data signals indicating acceleration repeatedly measured according to the preset moment to the controller after the moment t2. The controller may obtain a representative value (e.g., a maximum value, minimum value, mode value, intermediate value, and/or average value) of the impulse applied to the electronic device within the second time section 1030 after the moment t2, based on the data signals repeatedly transmitted from the plurality of acceleration sensors according to the preset moment. In an embodiment, the plurality of acceleration sensors may transmit the data signals to the controller including the representative value (e.g., the maximum value, minimum value, mode value, intermediate value, and/or average value) of the impulse identified within the second time section 1030, based on identifying that the magnitude of acceleration is maintained as the magnitude of the acceleration of gravity (e.g., the moment t3). The controller connected to the plurality of acceleration sensors according to an embodiment may obtain at least one of a distance, duration that the electronic device moves based on free fall during the second time section 1020, or an impulse applied to the electronic device within the third time section 1030. For example, the controller may obtain the impulse applied to the electronic device, based on the acceleration of the point A having relatively large magnitude from among the magnitude of acceleration of the point A included in the data signal received from the first acceleration sensor, or the magnitude of acceleration of the point B included in the data signal received from the second acceleration sensor.

As described above, the electronic device according to an embodiment may obtain information related to the motion of the electronic device based on the interrupt signals and/or data signals transmitted from the plurality of acceleration sensors. The information may be related to damage to the electronic device caused by free fall. For example, the information may include at least one of the duration that the electronic device fell, the distance that the electronic device moved by the falling, or the impulse applied to the electronic device. The obtained information may be used to display a screen, haptic feedback, and/or voice for guiding repair and/or diagnosis of the electronic device. The obtained information may be transmitted to an external electronic device (e.g., the external electronic device 890 of FIG. 8) different from the electronic device and used to statistically monitor durability of the electronic device.

Hereinafter, referring to FIG. 11, one or more signals exchanged between the plurality of acceleration sensors and the controller of the electronic device according to an embodiment will be described.

FIG. 11 is an example signal flowchart between a controller of an electronic device and a plurality of acceleration sensors, according to an embodiment. The electronic device of FIG. 11 may include the electronic device 101 of FIGS. 6A to 6B, FIGS. 7 to 9, and/or the electronic device of FIG. 10. For example, the controller of FIG. 11 may be an example of the controller 610 of FIGS. 6A to 6B. For example, the first acceleration sensor 620-1 and the second acceleration sensor 620-2 of FIGS. 6A to 6B may include a first acceleration sensor 620-1 and a second acceleration sensor 620-2 of FIG. 11.

Referring to FIG. 11, in operation 1105, the first acceleration sensor 620-1 of the electronic device according to an embodiment may identify that magnitude of acceleration is decreased to less than a first threshold. In operation 1110, the second acceleration sensor 620-2 of the electronic device according to an embodiment may identify that the magnitude of acceleration is decreased to less than the first threshold. The first acceleration sensor 620-1 and/or the second acceleration sensor 620-2 may identify falling of the electronic device, based on identifying acceleration having magnitude reduced below the first threshold during a preset duration. The first threshold may be a preset threshold (e.g., about 0 g) for detecting motion of the electronic device based on free fall. A moment at which the first acceleration sensor 620-1 and the second acceleration sensor 620-2 perform the operations 1105 and 1110 may be matched to the moment t1 of FIG. 10.

After identifying the acceleration having a magnitude decreased to less than the first threshold, in operation 1115, the first acceleration sensor 620-1 may identify that the magnitude of acceleration is increased to greater than or equal to a second threshold. In operation 1120, similar to operation 1115, the second acceleration sensor 620-2 may identify whether the magnitude of acceleration is increased to greater than or equal to the second threshold which is independent of the first threshold. Moments at which the operations 1115 and 1120 are performed may be matched to the moment t2 of FIG. 10. Based on identifying an acceleration having magnitude increased the second threshold, the first acceleration sensor 620-1 and the second acceleration sensor 620-2 may transmit interrupt signals 1116 and 1121 to the controller 610. The interrupt signals 1116 and 1121 may be independently transmitted to the controller 610 through the signal paths 640-1 and 640-2 of FIGS. 6A to 6B. The interrupt signals 1116 and 1121 may be signals for the first acceleration sensor 620-1 and the second acceleration sensor 620-2 to notify transmission of data signals including information related to the falling of the electronic device to the controller 610.

Referring to FIG. 11, in operation 1125, the first acceleration sensor 620-1 may obtain duration increased to greater than or equal to the second threshold after the magnitude of acceleration is decreased to less than the first threshold. The duration obtained by the first acceleration sensor 620-1 may be duration between moments at which each of the operations 1105 and 1115 is performed. The first acceleration sensor 620-1 may transmit a data signal 1126 indicating the duration to the controller 610 in response to obtaining of the duration. The data signal 1126 may be transmitted to the controller 610, through another signal path (e.g., the signal path 630 of FIGS. 6A to 6B) different from a signal path (e.g., the signal path 640-1 of FIGS. 6A to 6B) in which the interrupt signal 1116 in transmitted. The second threshold of the operations 1115 and 1120 may be adaptively and/or heuristically adjusted based on a range of measurable magnitudes of acceleration by the first acceleration sensor 620-1 and the second acceleration sensor 620-2.

In operation 1130, the second acceleration sensor 620-2 may obtain duration between a moment (e.g., when the operation 1110 is performed) when the magnitude of acceleration measured in the second acceleration sensor 620-2 is decreased to less than the first threshold and a moment (e.g., when operation 1120 is performed) when the magnitude is increased to greater than or equal to a second threshold. The second acceleration sensor 620-2 may transmit a data signal 1131 including the obtained duration to the controller 610. The second acceleration sensor 620-2 may transmit the data signal 1131 to the controller 610 through the other signal path (e.g., the signal path 630 of FIGS. 6A to 6B) different from a signal path (e.g., the signal path 640-2 of FIGS. 6A to 6B) in which the interrupt signal 1121 is transmitted.

After identifying that the magnitude of acceleration is increased to greater than or equal to the second threshold based on the operations 1115 and 1120, the first acceleration sensor 620-1 and the second acceleration sensor 620-2 may transmit data signals 1135 indicating acceleration repeatedly measured according to a preset moment to the controller 610. Similar to the data signals 1126 and 1131, the data signals 1135 may be transmitted through the other signal path (e.g., the signal path 630 of FIGS. 6A to 6B) different from a signal path (e.g., the signal path 640-2 of FIGS. 6A to 6B) in which the interrupt signals 1121 and 1116 are transmitted. The controller 610 may store the acceleration repeatedly measured according to the preset moment in each of the first acceleration sensor 620-1 and the second acceleration sensor 620-2 based on the data signals 1135.

Referring to FIG. 11, in operation 1140, the controller 610 of the electronic device according to an embodiment may identify that the magnitude of acceleration identified based on the data signals 1135 substantially maintained as the magnitude of the acceleration of gravity. A moment at which the controller 610 performs the operation 1140 may be matched to the moment t3 of FIG. 10. Before the operation 1140, for example, before the magnitude of acceleration identified based on the data signals 1135 substantially maintained as the magnitude of the acceleration of gravity, the controller 610 may store the magnitudes of acceleration identified based on the data signals 1135 in a memory (e.g., the memory 730 of FIG. 7).

After identifying the acceleration substantially maintained as the magnitude of the acceleration of gravity based on the operation 1140, in operation 1145, the controller 610 of the electronic device according to an embodiment may obtain an impulse applied to the electronic device based on magnitudes of acceleration received from acceleration sensors (e.g., the first acceleration sensor 620-1 and the second acceleration sensor 620-2). The controller 610 according to an embodiment may identify the impulse applied to the electronic device based on a representative value (e.g., a maximum value, minimum value, mode value, intermediate value and/or average value) of the magnitudes of acceleration included in each of the data signals 1135. For example, the controller 610 may select a maximum value of the magnitudes as an impulse applied to the electronic device.

Referring to FIG. 11, in operation 1150, the controller 610 of the electronic device according to an embodiment may obtain at least one of duration that the electronic device fell or a distance that the electronic device is moved, based on durations received from the acceleration sensors. The durations may include durations included in the data signals 1126 and 1131. The controller 610 may obtain the duration that the electronic device fell based on a representative value (e.g., a maximum value, minimum value, mode value, intermediate value, and/or average value) of the durations included in the data signals 1126 and 1131. For example, the controller 610 may select the maximum value of the durations as the duration that the electronic device fell. For example, based on the duration that the electronic device fell, the controller 610 may obtain the distance that the electronic device was moved. For example, in case of identifying duration t that the electronic device fell, the controller 610 may obtain a distance h that the electronic device is moved based on Equation 2.

$$h = \frac{1}{2} \times g \times {t}^{2} \qquad [ Equation 2 ]$$

g of [Equation 2] may be the magnitude (e.g., about 9.8%) of the acceleration of gravity. The order in which the controller 610 performs the operations 1145 and 1150 is not limited to an embodiment of FIG. 11. For example, the controller 610 may perform the operations 1145 and 1150 substantially simultaneously, or may perform according to a different order from the order of FIG. 11.

As described above, the controller 610 of the electronic device according to an embodiment may identify a worst parameter from among parameters related to the falling of the electronic device based on the data signals 1126, 1131, and 1135 measured from each of the plurality of acceleration sensors (e.g., the first acceleration sensor 620-1 and/or the second acceleration sensor 620-2) while the electronic device is moving based on the falling. The worst parameter may include a maximum value of the duration that the electronic device fell, the distance that the electronic device is moved, and the impulse applied to the electronic device. The worst parameter identified by the controller 610 may be used to identify damage to the electronic device. For example, the controller 610 may output text, vibration, and/or voice notifying the identification of information related to damage to the electronic device when identifying an impulse exceeding a preset impulse based on the data signals 1126, 1131, and 1135.

Hereinafter, operations of the acceleration sensors (e.g., the first acceleration sensor 620-1 and the second acceleration sensor 620-2) of FIG. 11 and/or the controller 610 will be described individually with reference to FIGS. 12 to 13.

FIG. 12 is an example flowchart of a plurality of acceleration sensors of an electronic device according to an embodiment. The electronic device of FIG. 12 may include the electronic device 101 of FIGS. 6A to 6B, FIGS. 7 to 9, and/or the electronic device of FIGS. 10 to 11. An operation of FIG. 12 may be performed, for example, by at least one of the plurality of acceleration sensors 620 of FIGS. 6A to 6B. The operation of FIG. 12 may be performed, for example, by the processing core 940 of FIG. 9.

Referring to FIG. 12, in operation 1210, an acceleration sensor in an electronic device according to an embodiment may identify acceleration based on a preset moment. The preset moment may be matched to a frequency of 400 Hz or more. The acceleration sensor may obtain a plurality of numerical values indicating acceleration, which is a vector along axes perpendicular to each other.

Referring to FIG. 12, in operation 1220, the acceleration sensor in the electronic device according to an embodiment may identify whether magnitude of acceleration is decreased to less than a first threshold during duration exceeding the preset duration. The preset duration may be a multiplier of the preset moment in the operation 1210. When the magnitude of acceleration is not decreased to less than the first threshold, or decreased to less than the first threshold during duration shorter than the preset duration (1220—No), the acceleration sensor may repeatedly identify the acceleration based on the operation 1210.

When the magnitude of acceleration is decreased to less than the first threshold during the duration exceeding the preset duration (1202—Yes), in operation 1230, the acceleration sensor in the electronic device according to an embodiment may increase a counter based on the preset moment. For example, the acceleration sensor may increase the counter by an integer of 1 at each preset moment. The counter may be a parameter stored in a memory (or register) of the acceleration sensor.

Referring to FIG. 12, in operation 1240, the acceleration sensor in the electronic device according to an embodiment may identify whether the magnitude of acceleration decreased to less than the first threshold is increased to greater than or equal to the second threshold. While the magnitude of acceleration is less than the second threshold (1240—No), the acceleration sensor may gradually increase the counter based on the operation 1230.

When the magnitude of acceleration is increased the second threshold (1240—Yes), in operation 1250, the acceleration sensor in the electronic device according to an embodiment may cease increasing the counter. Referring to FIG. 12, in operation 1260, the acceleration sensor in the electronic device according to an embodiment may transmit an interrupt signal to a controller (e.g., the controller 610 of FIGS. 6A to 6B). The interrupt signal may be transmitted to the controller through at least one of the signal paths 640 of FIGS. 6A to 6B. Referring to FIG. 12, in operation 1270, the acceleration sensor in the electronic device according to an embodiment may transmit a data signal including the counter to the controller. The data signal may be transmitted to the controller through a signal path (e.g., the signal path 630 of FIGS. 6A to 6B) different from a signal path in which the interrupt signal of the operation 1260 is transmitted.

Referring to FIG. 12, in operation 1280, the acceleration sensor in the electronic device according to an embodiment may transmit a data signal indicating the acceleration identified based on the preset moment to the controller. The data signal of the operation 1280 may be transmitted from the acceleration sensor to the controller through a signal path at which the data signal of operation 1270 is transmitted. Transmission of the data signal by the acceleration sensor based on the operation 1280 may be repeatedly performed based on the preset moment of the operations 1210 and 1230.

FIG. 13 is an example flowchart of a controller connected to a plurality of acceleration sensors of an electronic device, according to an embodiment. The electronic device of FIG. 13 may include the electronic device 101 of FIGS. 6A to 6B, and FIGS. 7 to 9, and the electronic device of FIGS. 10 to 11 to 12. An operation of FIG. 13 may be performed, for example, by the controller 610 of FIGS. 6A to 6B. The operation of FIG. 13 may be performed, for example, by the processing core 720 of FIG. 7.

Referring to FIG. 13, in operation 1310, the controller in the electronic device according to an embodiment may receive interrupt signals from acceleration sensors (e.g., the acceleration sensors 620 of FIGS. 6A to 6B). The interrupt signals may include the interrupt signals 1116 and 1121 of FIG. 11. The interrupt signals may be transmitted from the acceleration sensors to the controller based on operation 1360 of FIG. 13. The interrupt signals may be transmitted through a plurality of signal paths (e.g., the signal paths 640 of FIGS. 6A to 6B) connecting each of the controller and the acceleration sensors.

Referring to FIG. 13, in operation 1320, the controller in the electronic device according to an embodiment may receive data signals indicating duration that the electronic device fell from the acceleration sensors. The data signals may be transmitted through a signal path (e.g., the signal path 630 of FIGS. 6A to 6B) different from the plurality of signal paths in which the interrupt signals of operation 1310 are transmitted. The data signals in the operation 1320 may include the data signals 1126 and 1131 of FIG. 11. The data signals in the operation 1320 may be transmitted from the acceleration sensors based on that the acceleration sensors perform the operations 1125 and 1130 of FIG. 11.

Referring to FIG. 13, in operation 1330, the controller in the electronic device according to an embodiment may receive data signals including magnitude of acceleration identified repeatedly at each preset moment from the acceleration sensors. The data signals in the operation 1330 may be transmitted from the acceleration sensors to the controller, based on the preset moment at which the acceleration sensors repeatedly measure the acceleration. The data signals in the operation 1330 may be transmitted through a signal path (e.g., the signal path 630 of FIGS. 6A to 6B) different from the plurality of signal paths in which the interrupt signals of the operation 1310 are transmitted. The data signals in the operation 1330 may include the data signals 1135 of FIG. 11. The data signals in the operation 1330 may be transmitted from the acceleration sensors to the controller based on operation 1380 of FIG. 13.

Referring to FIG. 13, in operation 1340, the controller in the electronic device according to an embodiment may store the magnitude of acceleration included in the data signals received by the operation 1330. Referring to FIG. 13, in operation 1350, the controller in the electronic device according to an embodiment may identify whether the magnitude of acceleration included in the data signals substantially is maintained as the magnitude of the acceleration of gravity. When the magnitude of acceleration is not substantially maintained as the magnitude of the acceleration of gravity (1350—No), the controller may accumulate and store the magnitudes of acceleration, by repeatedly performing the operations 1330 and 1340.

When identifying that the magnitude of acceleration is substantially maintained as the magnitude of the acceleration of gravity (1350—YES), in operation 1360, the controller in the electronic device according to an embodiment may obtain information related to the falling of the electronic device based on the durations and/or the stored magnitudes f received from the acceleration sensors. Based on a maximum duration from among durations included in each of the received data signals based on the operation 1320, the controller may obtain the duration that the electronic device fell. The controller may obtain a distance that the electronic device is moved in the duration by applying the obtained duration to [Equation 2]. Based on a maximum value from among the magnitudes of acceleration accumulated by repetitive performance of the operations 1330 and 1340, the controller may obtain a maximum impulse applied to the electronic device.

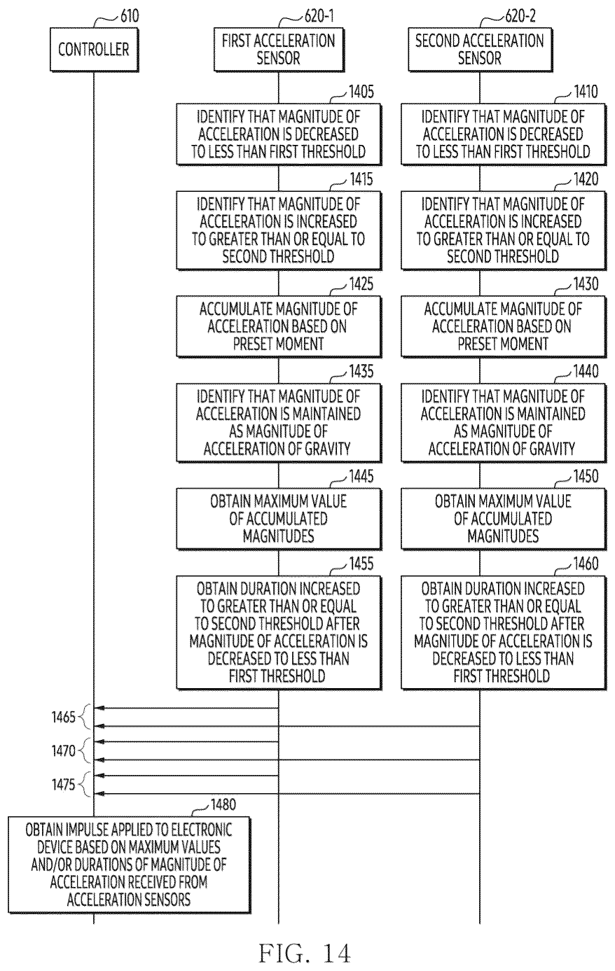

FIG. 14 is an example signal flowchart between a controller and a plurality of acceleration sensors of an electronic device according to an embodiment. The electronic device of FIG. 14 may include the electronic device 101 of FIGS. 6A to 6B, FIGS. 7 to 9, and/or the electronic device of FIG. 10. For example, the controller 610 of FIG. 14 may be an example of the controller 610 of FIGS. 6A to 6B. For example, the first acceleration sensor 620-1 and the second acceleration sensor 620-2 of FIG. 6A to 6B may include a first acceleration sensor 620-1 and a second acceleration sensor 620-2 of FIG. 14.

Operations of FIG. 14 may be performed substantially similar to those of FIG. 11. A description of the operations of FIG. 14 similar to those of FIG. 11 may be omitted to reduce repetition. For example, operation 1405 of the first acceleration sensor 620-1 and operation 1410 of the second acceleration sensor 620-2 may be performed substantially similar to the operations 1105 and 1110 of FIG. 11. For example, operation 1415 of the first acceleration sensor 620-1 and operation 1420 of the second acceleration sensor 620-2 may be performed substantially similar to the operations 1115 and 1120 of FIG. 11.

Referring to FIG. 14, after identifying acceleration having increased magnitude greater than or equal to a second threshold based on the operation 1415, the first acceleration sensor 620-1 of the electronic device according to an embodiment may accumulate the magnitude of acceleration based on a preset cycle, in operation 1425. The first acceleration sensor 620-1 may store the magnitude of acceleration repeatedly identified based on the preset moment in a memory of the first acceleration sensor 620-1. Referring to FIG. 14, in operation 1430, substantially similar to the operation 1425, the second acceleration sensor 620-2 may store the acceleration repeatedly measured based on the preset moment in a memory of the second acceleration sensor 620-2.

Referring to FIG. 14, identifying the acceleration maintained as the magnitude of the acceleration of gravity by the first acceleration sensor 620-1 and the second acceleration sensor 620-2 based on the operations 1435 and 1440, may be performed similar to the operation 1140 of the controller 610 of FIG. 11. After identifying the acceleration maintained as the magnitude of the gravitational acceleration, in operation 1445, the first acceleration sensor 620-1 may obtain a representative value (e.g., a maximum value) of the accumulated magnitudes based on the operation 1425. In operation 1450, the second acceleration sensor 620-2 may obtain a representative value (e.g., a maximum value) of the magnitudes stored in the second acceleration sensor 620-2 based on the operation 1430.

Referring to FIG. 14, in operation 1455, the first acceleration sensor 620-1 of the electronic device according to an embodiment may obtain duration increased to greater than or equal to the second threshold after the magnitude of acceleration is decreased to less than the first threshold, substantially similar to the operation 1125 of FIG. 11. In operation 1460, the second acceleration sensor 620-1 may obtain duration between moments when operations 1410 and 1420 are performed, substantially similar to operation 1130 of FIG. 11. An order in which the first acceleration sensor 620-1 performs the operations 1445 and 1455 or an order in which the second acceleration sensor 620-2 performs the operations 1450 and 1460, may not be limited to an order illustrated in FIG. 14.

Referring to FIG. 14, the first acceleration sensor 620-1 and the second acceleration sensor 620-2 may transmit interrupt signals 1465 to the controller 610. The interrupt signals 1465 may be transmitted to the controller 610 according to the signal paths 640-1 and 640-2 of FIGS. 6A to 6B. The first acceleration sensor 620-1 and the second acceleration sensor 620-2 may transmit data signals 1470 including representative values (e.g., maximum values) obtained based on the operations 1445 and 1450 to the controller 610. The first acceleration sensor 620-1 and the second acceleration sensor 620-2 may transmit data signals 1475 including durations obtained based on operations 1455 and 1460 to the controller 610. The order in which the first acceleration sensor 620-1 and the second acceleration sensor 620-2 transmit the data signals 1470 and 1475 may not be limited to the order of FIG. 14.

Referring to FIG. 14, in operation 1480, the controller 610 of the electronic device according to an embodiment may obtain information related to falling of the electronic device based on the maximum values and/or durations of the magnitude of acceleration received from the acceleration sensors. The information may include a relatively large value from among the maximum values indicated by the data signals 1470. For example, the information obtained by the controller 610 based on the operation 1480 may include a larger value from among the maximum values that each of the first acceleration sensor 620-1 and the second acceleration sensor 620-2 obtains based on the operations 1445 and 1450. The information may include relatively long duration from among the durations indicated by the data signals 1475. For example, the information obtained by the controller 610 based on the operation 1480 may include longer duration from among the durations that each of the first acceleration sensor 620-1 and the second acceleration sensor 620-2 obtains based on the operations 1455 and 1460. The information identified based on the operation 1480 may be used to identify a distance that the electronic device is moved based on the operation 1150 of FIG. 11, and/or [Equation 2].

As described above, the acceleration sensors (e.g., the first acceleration sensor 620-1 and the second acceleration sensor 620-2) of the electronic device according to an embodiment may independently measure data related to the falling of the electronic device and then transmit the measured data to the controller 610. The controller 610 may more accurately obtain information related to the falling of the electronic device based on the maximum value from among the data received from the acceleration sensors.

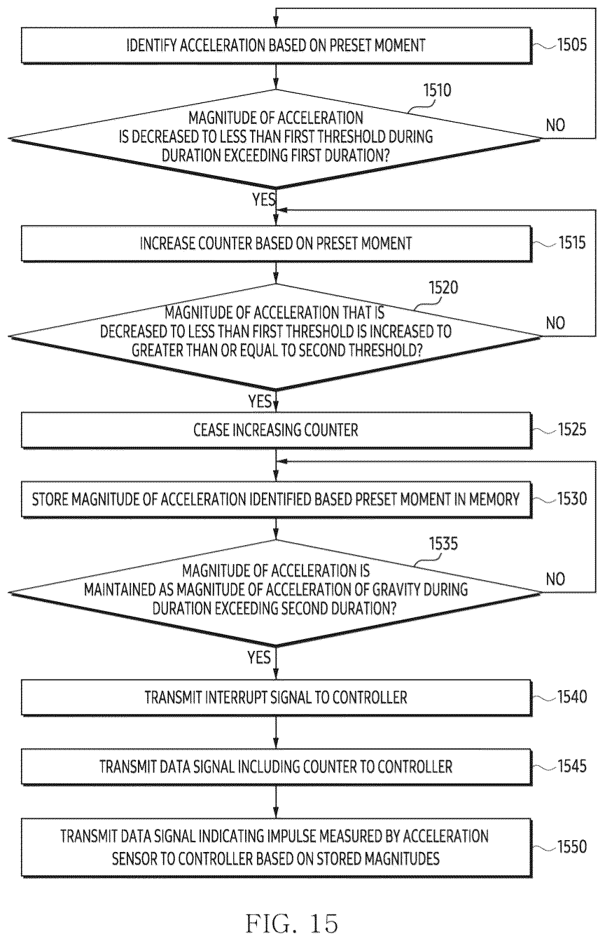

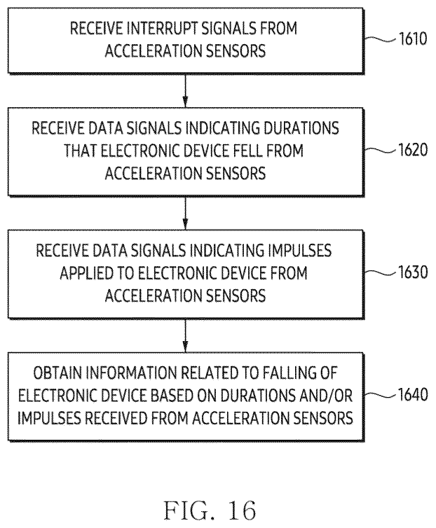

Hereinafter, the operations of the acceleration sensors of FIG. 14 (e.g., the first acceleration sensor 620-1 and the second acceleration sensor 620-2), and/or the controller 610 will be described individually with reference to FIGS. 15 to 16.

FIG. 15 is an example flowchart of a plurality of acceleration sensors of an electronic device according to an embodiment. The electronic device of FIG. 15 may include the electronic device 101 of FIGS. 6A to 6B, FIGS. 7 to 9, the electronic device of FIGS. 10 and/or 14. An operation of FIG. 15 may be performed, for example, by at least one of the plurality of acceleration sensors 620 of FIGS. 6A to 6B. The operation of FIG. 15 may be performed, for example, by the processing core 940 of FIG. 9.

At least one of operations of FIG. 15 may be performed substantially similar to the operations of FIG. 12. For example, operations 1505, 1510, 1515, 1520, and 1525 of the acceleration sensor of FIG. 15 may be performed similarly to the operations 1210, 1220, 1230, 1240, and 1250 of FIG. 12. The operation 1510 of FIG. 15 may be performed substantially similar to the operations 1405 and 1410 of FIG. 14. The operation 1520 of FIG. 15 may be performed substantially similar to the operations 1415 and 1420 of FIG. 14. Based on the operations 1505, 1510, 1515, 1520, 1525, the acceleration sensor may obtain a counter indicating duration, based on a preset moment (e.g., a cycle) of the operation 1515, between a moment at which magnitude of acceleration is decreased to less than a first threshold during a first duration of the operation 1510, and a moment at which the magnitude of acceleration is increased to greater than or equal to a second threshold of the operation 1520.

Referring to FIG. 15, in operation 1530, the acceleration sensor in the electronic device according to an embodiment may store the magnitude of acceleration identified based the preset moment (e.g., cycle) in a memory. The acceleration sensor may collect magnitudes of acceleration at each of moments distinguished by the preset moment based on the operation 1530 after the magnitude of acceleration is increased to greater than or equal to the second threshold of operation 1520.

Referring to FIG. 15, in operation 1535, the acceleration sensor in the electronic device according to an embodiment may identify whether the magnitude of acceleration substantially is maintained as magnitude of acceleration of gravity during duration exceeding a second duration. The second duration may be set independently with a first duration in the operation 1510. When the magnitude of acceleration has the magnitude of the acceleration of gravity during duration less than the second duration, or when the magnitude of acceleration is not substantially matched to the magnitude of the acceleration of gravity (1535—No), the controller may repeatedly perform, based on the preset moment (e.g., cycle), storing the magnitude of acceleration based on the operation 1530.

When the magnitude of acceleration is substantially maintained as the magnitude of the acceleration of gravity during a duration exceeding the second duration (1535—yes), in operation 1540, the acceleration sensor in the electronic device according to an embodiment may transmit an interrupt signal (e.g., interrupt signals 1465 of FIG. 14) to the controller (e.g., the controller 610 of FIGS. 6A to 6B). Referring to FIG. 15, in operation 1545, the acceleration sensor in the electronic device according to an embodiment may transmit a data signal including a counter to the controller. The operation 1545 of FIG. 15 may include the operations 1455 and 1460 of FIG. 14. Referring to FIG. 15, in operation 1550, the acceleration sensor in the electronic device according to an embodiment may transmit a data signal indicating an impulse measured by the acceleration sensor to the controller based on the magnitudes stored based on the operation 1530. The operation 1550 of FIG. 15 may include the operations 1445 and 1450 of FIG. 14. For example, the acceleration sensor may transmit a data signal including a maximum value from among the magnitudes to the controller. The data signal of the operations 1545 and 1550 may be transmitted to the controller through another signal path different from a signal path in which the interrupt signal of the operation 1540 is transmitted. The data signal in the operation 1545 may include the data signals 1475 of FIG. 14. The data signal in the operation 1550 may include the data signals 1470 of FIG. 14.

FIG. 16 is an example flowchart of a controller connected to a plurality of acceleration sensors of an electronic device according to an embodiment. The electronic device of FIG. 16 may include the electronic device 101 of FIGS. 6A to 6B, FIGS. 7 to 9, and the electronic device of FIGS. 10, and 14 to 15. An operation of FIG. 16 may be performed, for example, by the controller 610 of FIGS. 6A to 6B. The operation of FIG. 16 may be performed, for example, by the processing core 720 of FIG. 7.

Referring to FIG. 16, in operation 1610, the controller in the electronic device according to an embodiment may receive interrupt signals from the acceleration sensors (e.g., the acceleration sensors 620 of FIGS. 6A to 6B). The interrupt signals may include the interrupt signals 1465 of FIG. 14. The interrupt signals may be transmitted from the acceleration sensors to the controller based on the operation 1540 of FIG. 15. The interrupt signals may be independently transmitted from each of the acceleration sensors to the controller through the signal paths 640 of FIGS. 6A to 6B.

Referring to FIG. 16, in operation 1620, the controller in the electronic device according to an embodiment may receive data signals indicating durations that the electronic device fell from the acceleration sensors. The data signals may be transmitted from the acceleration sensors to the controller through the signal path 630 of FIGS. 6A to 6B. The data signals may be transmitted from the acceleration sensors to the controller based on the operation 1545 of FIG. 15. For example, numerical values included in the data signals may be counters increased by each of the acceleration sensors based on the operations 1515 and 1520 of FIG. 15.

Referring to FIG. 16, in operation 1630, the controller in the electronic device according to an embodiment may receive data signals indicating impulses applied to the electronic device from the acceleration sensors. Similar to the data signals of the operation 1620, the data signals may be transmitted from the acceleration sensors to the controller through the signal path 630 of FIGS. 6A to 6B. The data signals may be transmitted from the acceleration sensors to the controller based on the operation 1550 of FIG. 15. The impulses included in the data signals may be a maximum value of the impulse in which each of the acceleration sensors measures.

Referring to FIG. 16, in operation 1640, the controller in the electronic device according to an embodiment may obtain information related to falling of the electronic device based on the durations and the impulses received from the acceleration sensors. The information may include a maximum value from among the durations included in the data signals received based on the operation 1620. The information may indicate the maximum value based on a counter applied to a preset moment. The controller may obtain a moving distance of the electronic device based on the maximum value of the durations. The information may include a maximum value from among the impulse included in the data signals received based on operation 1630.

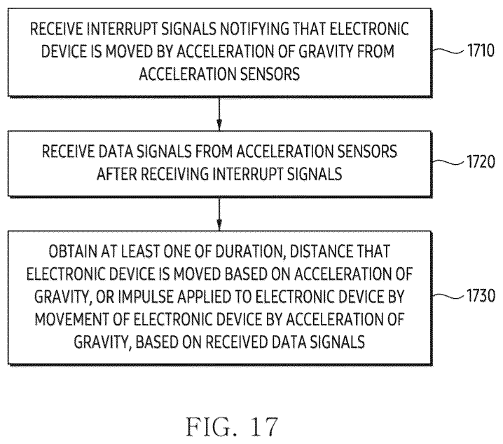

FIG. 17 is an example flowchart of a controller connected to a plurality of acceleration sensors of an electronic device according to an embodiment. The electronic device of FIG. 17 may include the electronic device 101 of FIGS. 6A to 6B, FIGS. 7 to 9, and the electronic device of FIGS. 10 to 16. An operation of FIG. 17 may be performed, for example, by the controller 610 of FIGS. 6A to 6B. The operation of FIG. 17 may be performed, for example, by the processing core 720 of FIG. 7.

Referring to FIG. 17, in operation 1710, the controller in the electronic device according to an embodiment may receive interrupt signals (e.g., the interrupt signals 1116 in FIG. 11 and/or the interrupt signals 1465 in FIG. 14) notifying that the electronic device is moved by acceleration of gravity from the acceleration sensors. According to an embodiment, the electronic device may include a plurality of signal paths (e.g., the signal paths 640 of FIGS. 6A to 6B) for connecting each of the acceleration sensors to the controller. The controller may receive the interrupt signals from the acceleration sensors through the plurality of signal paths.

Referring to FIG. 17, in operation 1720, the controller in the electronic device according to an embodiment may receive data signals from the acceleration sensors after receiving the interrupt signals of the operation 1710. The controller may receive the data signals in response to the receiving of the interrupt signals. The data signals may include the data signals 1126, 1131, 1135 of FIG. 11, and/or data signals 1470 and 1475 of FIG. 14.

Referring to FIG. 17, in operation 1730, the controller in the electronic device according to an embodiment may obtain at least one of duration, a distance that the electronic device is moved based on acceleration of gravity, or an impulse applied to the electronic device by a movement of the electronic device, based on the received data signals. The duration of the operation 1730 may be determined as a maximum value or an average value of the durations included in the data signals received from the acceleration sensors by the controller. The distance of the operation 1730 may be determined based on the duration of the operation 1730, and/or [Equation 2]. The impulse of the operation 1730 may be determined as a maximum value or an average value of magnitudes of acceleration included in the data signals of the operation 1720. At least one of the duration, the distance, or the impulse of the operation 1730 may be stored in a memory (e.g., the memory 130 of FIG. 1) of the electronic device, or may be transmitted to an external electronic device (e.g., the external electronic device 890 of FIG. 8) different from the electronic device.

As described above, the electronic device according to an embodiment may obtain interrupt signals for notifying detection of free fall of the electronic device, and the data signals indicating motion of the electronic device by the free fall from the plurality of acceleration sensors. The electronic device may obtain information for identifying damage to the electronic device by the free fall based on the data signals. For example, the information may include at least one of duration that the electronic device has moved by the free fall, a distance that the electronic device is moved by the free fall, or an impulse applied to the electronic device.

In an embodiment, as the electronic device includes one or more acceleration sensors for identifying a shape of a flexible display and/or a housing, a method for calibrating information related to a movement (e.g., free fall) of the electronic device may be required by using the one or more acceleration sensors. As described above, the electronic device according to an embodiment may include the housing that is deformable along at least one folding axis. The electronic device may include a plurality of acceleration sensors respectively positioned in portions of the deformable housing, for example, which may be distinguished by the at least one folding axis. The electronic device may include a controller operably coupled to the plurality of acceleration sensors. The controller of the electronic device may be configured to receive interrupt signals notifying that the electronic device is moved by acceleration of gravity applied to the electronic device from the plurality of acceleration sensors. The controller may be configured to receive data signals based on acceleration measured by the plurality of acceleration sensors in response to receiving of the interrupt signals. The controller may be configured to obtain at least one of duration, a distance that the electronic device is moved based on the acceleration of gravity, or an impulse applied to the electronic device by a movement of the electronic device based on the acceleration of gravity, based on the data signals. The electronic device according to an embodiment may calibrate and/or obtain information related to the movement (e.g., free fall) of the electronic device by using the one or more acceleration sensors for identifying the shape of the flexible display and/or the housing.

For example, the electronic device may further comprise a plurality of signal paths to connect each of the plurality of acceleration sensors to the controller. The controller may be configured to receive, through at least one of the plurality of signal paths, at least one of the interrupt signals from at least one of the plurality of acceleration sensors.

For example, the controller may be configured to receive, through other signal paths different from the plurality of signal paths, the data signals from the plurality of acceleration sensors.

For example, the controller may be configured to receive, in a time section after a first moment receiving the interrupt signals and before a second moment that the movement of the electronic device based on the acceleration of gravity is stopped, the data signals from the plurality of acceleration sensors. The controller may be configured to, based on the data signals, select a representative value of impulses respectively measured by the plurality of acceleration sensors, as the impulse applied to the electronic device by the movement of the electronic device based on the acceleration of gravity.

For example, the controller may be configured to, based on the data signals, identify, from the plurality of acceleration sensors, durations that the electronic device is moved by the acceleration of gravity. The controller may be configured to select a maximum value among the identified durations, as duration that the electronic device is moved based on the acceleration of gravity.

For example, the plurality of acceleration sensors may be configured to obtain, based on a preset moment, a plurality of first parameters indicating the acceleration of the electronic device, which are corresponding to a plurality of axes. The plurality of acceleration sensors may be configured to identify magnitude of the acceleration by combining the plurality of first parameters. The plurality of acceleration sensors may be configured to, based on identifying that the magnitude of the acceleration is lower than preset magnitude during preset duration that is a multiplier of the preset moment, gradually increase a second parameter to measure the duration based on the preset moment.

For example, the preset magnitude may be first preset magnitude. The plurality of acceleration sensors may be configured to, while the second parameter is gradually increased based on the preset moment, cease gradually increasing the second parameter based on identifying that the magnitude of the acceleration is increased to be greater than or equal to second preset magnitude. The plurality of acceleration sensors may be configured to, based on the ceasing increasing the second parameter, transmit the interrupt signals to the controller.

For example, the plurality of acceleration sensors may be configured to, after transmitting the interrupt signals to the controller, transmit the data signals including the magnitude of the acceleration measured based on the preset moment.

For example, the plurality of acceleration sensors may be configured to, in a time section from a first moment transmitting the interrupt signals to the controller to a second moment identifying that the magnitude of the acceleration is maintained as third preset magnitude matched to magnitude of the acceleration of gravity during another preset duration that is a multiplier of the preset moment, obtain a representative value of the magnitude of the acceleration measured based on the preset moment. The plurality of acceleration sensors may be configured to transmit, to the controller, the data signals including the obtained representative value.

For example, the electronic device may further comprise communication circuitry. The controller may be configured to transmit, to an external electronic device using the communication circuitry, at least one of the duration, the distance, or the impulse.

As described above, a method of an electronic device according to an embodiment may comprise receiving, from a plurality of acceleration sensors positioned distinct portions of the electronic device, interrupt signals indicating that the electronic device is moved by acceleration of gravity applied to the electronic device. The method of the electronic device may comprise receiving, in response to the receiving of the interrupt signals, data signals based on acceleration estimated by the plurality of acceleration sensors. The method of the electronic device may comprise obtaining, based on the data signals, at least one of duration, a distance that the electronic device is moved based on the acceleration of gravity, or an impulse applied to the electronic device based on the movement of the electronic device based on the acceleration of gravity.

For example, the receiving the interrupt signals may further comprise receiving, through at least one of the plurality of signal paths respectively connected to each of the plurality of acceleration sensors, the interrupt signals.

For example, the receiving the data signals may further comprise receiving, through other signal paths different from the plurality of signal paths, the data signals from the plurality of acceleration sensors.

For example, the receiving the data signals may further comprise receiving, in a time section after a first moment receiving the interrupt signals and before a second moment that a movement of the electronic device based on the acceleration of gravity is stopped, the data signals from the plurality of acceleration sensors. The obtaining may further comprise, based on the data signals, selecting a representative value of impulses respectively measured by the plurality of acceleration sensors, as the impulse applied to the electronic device by the movement of the electronic device based on the acceleration of gravity.

The obtaining may further comprise, based on the data signals, identifying, from the plurality of acceleration sensors, durations that the electronic device is moved by the acceleration of gravity. The obtaining may further comprise, selecting a representative value among the identified durations, as duration that the electronic device is moved based on the acceleration of gravity.

As described above, an electronic device according to an embodiment may comprise a housing including a plurality of portions pivotably interconnected based on a folding axis. The electronic device may comprise a plurality of acceleration sensors for identifying an angle between the plurality of portions and the folding axis, the plurality of acceleration sensors being respectively positioned at the plurality of portions. The electronic device may comprise a controller operably coupled to the plurality of acceleration sensors. The controller may be configured to be coupled to the plurality of acceleration sensors via one or more first signal paths for receiving a data signal indicating acceleration estimated by the plurality of acceleration sensors. The controller may be configured to be coupled to a first acceleration sensor among the plurality of acceleration sensors via a second signal path, which is different from the first signal path, for receiving an interrupt signal notifying that a movement of the electronic device based on acceleration of gravity is identified by the first acceleration sensor. The controller may be configured to be coupled to a second acceleration sensor among the plurality of acceleration sensors via a third signal path, which is different from the first signal path and the second signal path, for receiving another interrupt signal notifying that the movement of the electronic device based on the acceleration of gravity is identified by the second acceleration sensor.

For example, the controller may be configured to receive at least one of the interrupt signal or the another interrupt signal using at least one of the second signal path, or the third signal path. The controller may be configured to, based on at least one of the interrupt signal or the another interrupt signal, receive, from the plurality of acceleration sensors using the first signal path, the data signal indicating durations that the electronic device is moved by the acceleration of gravity, which are measured by the plurality of acceleration sensors. The controller may be configured to, based on a maximum value among the durations, obtain a distance that the electronic device is moved by the acceleration of gravity.

For example, the controller may be configured to receive at least one of the interrupt signal or the another interrupt signal using at least one of the second signal path, or the third signal path. The controller may be configured to, based on the data signal after receiving the at least one of the interrupt signal or the another interrupt signal, identify a representative value of the acceleration measured by the plurality of acceleration sensors in a time section in which the acceleration is different from the acceleration of gravity. The controller may be configured to, based on the identified representative value, obtain an impulse applied to the electronic device.

For example, the controller may be configured to, in response to obtaining the impulse greater than a preset impulse, output at least one of a screen, an audio signal, or haptic feedback requiring diagnosis of the electronic device.

For example, the electronic device may further comprise communication circuitry. The controller may be configured to, based on at least one of the interrupt signal or the another interrupt signal, obtain information associated with the movement of the electronic device by the acceleration of gravity using the data signal received from the plurality of acceleration sensors through the first signal path. The controller may be configured to transmit, to an external electronic device different from the electronic device through the communication circuitry, the obtained information.

As described above, an electronic device according to an embodiment may comprise a first housing, a second housing, a folding housing for pivotably connecting the first housing and the second housing with respect to a folding axis, a first acceleration sensor included in the first housing, a second acceleration sensor included in the second housing, and a controller operably coupled to the first acceleration sensor and the second acceleration sensor. The controller may be configured to receive, from at least one of the first acceleration sensor or the second acceleration sensor, a first signal indicating detection of acceleration having magnitude less than preset magnitude. The controller may be configured to receive, from the first acceleration sensor, a second signal indicating duration that the first acceleration sensor measures acceleration less than the preset magnitude based on the receiving of the first signal. The controller may be configured to receive, from the second acceleration sensor, a third signal indicating duration that the second acceleration sensor measures the acceleration less than the preset magnitude based on the receiving of the first signal. The controller may be configured to obtain duration that the electronic device is moved at least based on gravity based on the period indicated by the second signal and the period indicated by the third signal.

As described above, an electronic device according to an embodiment may comprise a first housing, a second housing, a folding housing for pivotably connecting the first housing and the second housing with respect to a folding axis, a first acceleration sensor included in the first housing, a second acceleration sensor included in the second housing, and a controller operably coupled to the first acceleration sensor and the second acceleration sensor. The controller may be configured to receive, from at least one of the first acceleration sensor or the second acceleration sensor, a first signal indicating detection of acceleration having magnitude less than preset magnitude. The controller may be configured to receive, from the first acceleration sensor, a second signal indicating an impulse identified by the first acceleration sensor based on the receiving of the first signal. The controller may be configured to receive, from the second acceleration sensor, a third signal indicating an impulse identified by the second acceleration sensor, based on the receiving of the first signal. The controller may be configured to obtain an impulse applied to the electronic device based on the impulse indicated by the second signal and the impulse indicated by the third signal.

The device described above may be implemented as a hardware component, a software component, and/or a combination of a hardware component and a software component. For example, the devices and components described in the embodiments may be implemented by using one or more general purpose computers or special purpose computers, such as a processor, controller, arithmetic logic unit (ALU), digital signal processor, microcomputer, field programmable gate array (FPGA), programmable logic unit (PLU), microprocessor, or any other device capable of executing and responding to instructions. The processing device may perform an operating system (OS) and one or more software applications executed on the operating system. In addition, the processing device may access, store, manipulate, process, and generate data in response to the execution of the software. There is a case that one processing device is described as being used, but a person who has ordinary knowledge in the relevant technical field may see that the processing device may include a plurality of processing elements and/or a plurality of types of processing elements. For example, the processing device may include a plurality of processors or one processor and one controller. In addition, another processing configuration, such as a parallel processor, is also possible.

The software may include a computer program, code, instruction, or a combination of one or more thereof, and may configure the processing device to operate as desired or may command the processing device independently or collectively. The software and/or data may be embodied in any type of machine, component, physical device, computer storage medium, or device, to be interpreted by the processing device or to provide commands or data to the processing device. The software may be distributed on network-connected computer systems and stored or executed in a distributed manner. The software and data may be stored in one or more computer-readable recording medium.

The method according to the embodiment may be implemented in the form of a program command that may be performed through various computer means and recorded on a computer-readable medium. In this case, the medium may continuously store a program executable by the computer or may temporarily store the program for execution or download. In addition, the medium may be various recording means or storage means in the form of a single or a combination of several hardware, but is not limited to a medium directly connected to a certain computer system, and may exist distributed on the network. Examples of media may include a magnetic medium such as a hard disk, floppy disk, and magnetic tape, optical recording medium such as a CD-ROM and DVD, magneto-optical medium, such as a floptical disk, and those configured to store program instructions, including ROM, RAM, flash memory, and the like. In addition, examples of other media may include recording media or storage media managed by app stores that distribute applications, sites that supply or distribute various software, servers, and the like.

As described above, although the embodiments have been described with limited examples and drawings, a person who has ordinary knowledge in the relevant technical field is capable of various modifications and transform from the above description. For example, even if the described technologies are performed in a different order from the described method, and/or the components of the described system, structure, device, circuit, and the like are coupled or combined in a different form from the described method, or replaced or substituted by other components or equivalents, appropriate a result may be achieved.

Therefore, other implementations, other embodiments, and those equivalent to the scope of the claims are in the scope of the claims described later.

The electronic device according to one or more embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

One or more embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. A singular form of a noun corresponding to an item may include one or more of the things unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), it means that the element may be coupled with the other element directly (e.g., wiredly), wirelessly, or via a third element.

As used in connection with one or more embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

One or more embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between a case in which data is semi-permanently stored in the storage medium and a case in which the data is temporarily stored in the storage medium.

According to an embodiment, a method according to one or more embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to one or more embodiments, each component (e.g., a module or a program) of the above-described components may include a single entity or multiple entities, and some of the multiple entities may be separately disposed in different components. According to one or more embodiments, one or more of the above-described components may be omitted, or one or more other components may be added. Alternatively or additionally, a plurality of components (e.g., modules or programs) may be integrated into a single component. In such a case, according to one or more embodiments, the integrated component may still perform one or more functions of each of the plurality of components in the same or similar manner as they are performed by a corresponding one of the plurality of components before the integration. According to one or more embodiments, operations performed by the module, the program, or another component may be carried out sequentially, in parallel, repeatedly, or heuristically, or one or more of the operations may be executed in a different order or omitted, or one or more other operations may be added.

No claim element is to be construed under the provisions of 35 U.S.C. § 112, sixth paragraph, unless the element is expressly recited using the phrase “means for” or “means.”

What is claimed is:

1. An electronic device comprising:
a deformable housing along at least one folding axis;
a plurality of acceleration sensors respectively positioned at portions of the deformable housing;
a controller operably coupled to the plurality of acceleration sensors,
wherein the controller is configured to:
receive, from the plurality of acceleration sensors, interrupt signals indicating that the electronic device is moved by acceleration of gravity applied to the electronic device;
based on the received interrupt signals and based on acceleration measured by the plurality of acceleration sensors, receive data signals; and
based on the received data signals, obtain, at least one of duration,
a distance that the electronic device is moved in accordance with the acceleration of gravity, or
an impulse applied to the electronic device based on movement of the electronic device, which corresponds to the acceleration of gravity.

2. The electronic device of claim 1, further comprises a plurality of signal paths to connect at least one of the plurality of acceleration sensors to the controller,
wherein the controller is further configured to receive, through at least one of the plurality of signal paths, at least one of the interrupt signals, from at least one of the plurality of acceleration sensors.

3. The electronic device of claim 2, wherein the controller is further configured to receive, through other signal paths different from the plurality of signal paths, the data signals from the plurality of acceleration sensors.

4. The electronic device of claim 1, wherein the controller is further configured to:
receive, in a time section after a first moment receiving the interrupt signals and before a second moment that a movement of the electronic device, based on the acceleration of gravity is stopped, the data signals from the plurality of acceleration sensors; and
based on the data signals, select a representative value of impulses respectively measured by the plurality of acceleration sensors, as the impulse applied to the electronic device by the movement of the electronic device, which corresponds to the acceleration of gravity.

5. The electronic device of claim 1, wherein the controller is further configured to:
based on the data signals, identify, from the plurality of acceleration sensors, durations that the electronic device is moved by the acceleration of gravity;
select a maximum value among the identified durations, as duration that the electronic device is moved in accordance with the acceleration of gravity.

6. The electronic device of claim 1, wherein the plurality of acceleration sensors are configured to:
obtain, based on a preset moment, a plurality of first parameters indicating the acceleration of the electronic device, which corresponds to a plurality of axes;
identify magnitude of the acceleration by combining the plurality of first parameters; and
based on identifying that the magnitude of the acceleration is lower than preset magnitude during preset duration that is a multiplier of the preset moment, increase a second parameter to measure the duration based on the preset moment.

7. The electronic device of claim 6, wherein the preset magnitude is first preset magnitude, and
wherein the plurality of acceleration sensors are configured to:
based on the second parameter that is increased based on the preset moment and based on identifying that the magnitude of the acceleration is increased to be greater than or equal to second preset magnitude, cease increasing the second parameter,
based on the ceasing increasing the second parameter, transmit the interrupt signals to the controller.

8. The electronic device of claim 1, wherein the plurality of acceleration sensors are configured to, after transmitting the interrupt signals to the controller, transmit the data signals including the magnitude of the acceleration measured based on the preset moment.

9. The electronic device of claim 1, wherein the plurality of acceleration sensors are configured to:
in a time section from a first moment transmitting the interrupt signals to the controller to a second moment identifying that the magnitude of the acceleration is maintained as third preset magnitude matched to magnitude of the acceleration of gravity during another preset duration that is a multiplier of the preset moment, obtain a representative value of the magnitude of the acceleration measured based on the preset moment; and
transmit, to the controller, the data signals including the obtained representative value.

10. The electronic device of claim 5, further comprises communication circuitry,
wherein the controller is further configured to transmit, to an external electronic device using the communication circuitry, at least one of the duration, the distance, or the impulse.

11. A method of an electronic device, the method comprising:
receiving, from a plurality of acceleration sensors positioned in distinct portions of the electronic device, interrupt signals indicating that the electronic device is moved in accordance with acceleration of gravity applied to the electronic device;
based on the received interrupt signals and based on acceleration measured by the plurality of acceleration sensors, receiving data signals; and
based on the data signals, obtaining, at least one of duration,
a distance that the electronic device is moved in accordance with the acceleration of gravity, or
an impulse applied to the electronic device based on the movement of the electronic device, which corresponds to the acceleration of gravity.

12. The method of claim 11, wherein the receiving the interrupt signals further comprises receiving, through at least one of a plurality of signal paths respectively connected to each of the plurality of acceleration sensors, the interrupt signals.

13. The method of claim 12, wherein the receiving the data signals further comprises receiving, through other signal paths different from the plurality of signal paths, the data signals from the plurality of acceleration sensors.

14. The method of claim 11, wherein the receiving the data signals further comprises:
receiving, in a time section after a first moment receiving the interrupt signals and before a second moment that a movement of the electronic device based on the acceleration of gravity is stopped, the data signals from the plurality of acceleration sensors,
wherein the obtaining further comprises, based on the data signals, selecting a representative value of impulses respectively measured by the plurality of acceleration sensors, as the impulse applied to the electronic device by the movement of the electronic device based on the acceleration of gravity.

15. The method of claim 11, wherein the obtaining the distance or the impulse further comprises:
based on the data signals, identifying, from the plurality of acceleration sensors, durations that the electronic device is moved by the acceleration of gravity;
selecting a representative value among the identified durations, as duration that the electronic device is moved, which corresponds to the acceleration of gravity.

16. An electronic device comprising:
a housing comprising a plurality of portions pivotably interconnected based on a folding axis;
a plurality of acceleration sensors configured to identify an angle between the plurality of portions, and the folding axis, wherein the plurality of acceleration sensors are respectively positioned at the plurality of portions; and
a controller operably coupled to the plurality of acceleration sensors;
wherein the controller is configured to be coupled to:
the plurality of acceleration sensors, via a plurality of signal paths, configured to receive a data signal indicating acceleration measured by the plurality of acceleration sensors, wherein the plurality of signal paths comprise a first signal path;
a first acceleration sensor among the plurality of acceleration sensors via a second signal path, which is different from the first signal path, for receiving an interrupt signal indicating that a movement of the electronic device based on acceleration of gravity is identified by the first acceleration sensor; and
a second acceleration sensor among the plurality of acceleration sensors via a third signal path, which is different from the first signal path and the second signal path, for receiving another interrupt signal indicating that the movement of the electronic device based on the acceleration of gravity is identified by the second acceleration sensor.

17. The electronic device of claim 16, wherein the controller is further configured to:
receive at least one of the interrupt signal or the another interrupt signal using at least one of the second signal path, or the third signal path;
based on at least one of the interrupt signal or the another interrupt signal, receive, from the plurality of acceleration sensors using the first signal path, the data signal indicating durations that the electronic device is moved by the acceleration of gravity, which are measured by the plurality of acceleration sensors; and
based on a maximum value among the durations, obtain a distance that the electronic device is moved by the acceleration of gravity.

18. The electronic device of claim 16, wherein the controller is further configured to:
receive at least one of the interrupt signal or the another interrupt signal using at least one of the second signal path, or the third signal path,
based on the data signal after receiving at least one of the interrupt signal or the another interrupt signal, identify a representative value of the acceleration measured by the plurality of acceleration sensors in a time section in which the acceleration is different from the acceleration of gravity; and
based on the identified representative value, obtain an impulse applied to the electronic device.

19. The electronic device of claim 18, wherein the controller is further configured to, based on obtaining the impulse greater than a preset impulse, output at least one of a screen, an audio signal, or haptic feedback requiring diagnosis of the electronic device.

20. The electronic device of claim 16, further comprises communication circuitry,
wherein the controller is further configured to:
based on at least one of the interrupt signal or the another interrupt signal, obtain information associated with the movement of the electronic device by the acceleration of gravity using the data signal received from the plurality of acceleration sensors through the first signal path; and
transmit, to an external electronic device different from the electronic device through the communication circuitry, the obtained information.
